(19) United States
(12) Patent Application Publication
(10) Pub. No.: US 2023/0080420 A1
(43) Pub. Date: Mar. 16, 2023

(54) DISPLAY APPARATUS

(71) Applicant: SONY SEMICONDUCTOR SOLUTIONS CORPORATION, Kanagawa (JP)

(72) Inventor: Kengo HAYASHI, Kanagawa (JP)

(73) Assignee: SONY SEMICONDUCTOR SOLUTIONS CORPORATION, Kanagawa (JP)

(21) Appl. No.: 17/797,838

(22) PCT Filed: Jan. 14, 2021
(86) PCT No.: PCT/JP2021/001101

§ 371 Date: Aug. 5, 2022

(30) Foreign Application Priority Data
Feb. 19, 2020 (JP) 2020-025898

(51) Int. Cl. G02B 27/01; G02B 25/00

(52) U.S. Cl. CPC G02B 27/0172; G02B 27/0149; G02B 27/0179; G02B 27/0101; G02B 25/001; G02B 2027/015; G02B 2027/0178; G02B 2027/0187; G02B 2027/0138

(57) ABSTRACT

A display apparatus of the present disclosure includes an eyepiece optical device and an image display device, the image display device includes an image forming device, a transfer optical device, a control unit, a first position detection device, a second position detection device, and a transfer-optical-device control device, the eyepiece optical device forms an image from the transfer optical device on a retina of an observer, the transfer-optical-device control device controls the transfer optical device such that the image incident from the image forming device reaches the eyepiece optical device under the control of the control unit on the basis of position information of the eyepiece optical device detected by the first position detection device, and the control unit corrects a position detected by the first position detection device on the basis of position information of the eyepiece optical device detected by the second position detection device.

### TECHNICAL FIELD

The present disclosure relates to a display apparatus.

### BACKGROUND ART

A head-mounted image display device to be mounted on a head of an observer is known from, for example, Japanese Patent Application Laid-Open No. 2005-309264. An image display device 1 disclosed in this patent publication includes a head-mounted unit 6 to be mounted on the head of the observer and a body carrying unit 7 carried by a body of the observer. The head-mounted unit 6 is provided with a convex lens 8 included in a transfer optical system 5 and a part of a direction/distance detection system. The head-mounted unit 6 includes a light emitting unit R including an infrared LED and an actuator 27 and a drive circuit 28 for moving the convex lens 8.

### CITATION LIST

### Patent Document

Patent Document 1: Japanese Patent Application Laid-Open No. 2005-309264

### SUMMARY OF THE INVENTION

### Problems to be Solved by the Invention

By the way, in the technology disclosed in the above patent publication, a power supply (battery) is required for the light emitting unit R, the actuator 27, and the drive circuit 28 provided in the head-mounted unit 6. This imposes a burden on the observer, such as an increase in mass and size of the head-mounted unit 6. Assuming that the light emitting unit R, the actuator 27, and the drive circuit 28 are removed and only the convex lens 8 is mounted on the head-mounted unit 6, a positional relationship between the body carrying unit and the head-mounted unit collapses when the observer moves, and a projected image deviates from a pupil of the observer. As a result, there arises a problem that it is difficult to observe the image.

Therefore, an object of the present disclosure is to provide a display apparatus having a configuration and structure that do not impose a burden on an observer.

### Solutions to Problems

Display apparatuses according to first and second aspects of the present disclosure for achieving the above object include:

an eyepiece optical device; and

an image display device including an image forming device and a transfer optical device that emits an image incident from the image forming device to the eyepiece optical device, in which

the eyepiece optical device and the image display device are spatially separated from each other,

the eyepiece optical device forms the image from the transfer optical device on a retina of an observer, and

the image display device further includes

a control unit,

a first position detection device and a second position detection device that detect a position of the eyepiece optical device, and

a transfer-optical-device control device.

Further, in the display apparatus according to the first aspect of the present disclosure, the transfer-optical-device control device controls the transfer optical device such that the image incident from the image forming device reaches the eyepiece optical device under the control of the control unit on the basis of position information of the eyepiece optical device detected by the first position detection device, and the control unit corrects the position detected by the first position detection device on the basis of position information of the eyepiece optical device detected by the second position detection device.

Further, in the display apparatus according to the second aspect of the present disclosure, the transfer-optical-device control device controls the transfer optical device such that the image incident from the image forming device reaches the eyepiece optical device under the control of the control unit on the basis of position information of the eyepiece optical device detected by the first position detection device, and the control unit controls formation of the image in the image forming device on the basis of the position information of the eyepiece optical device detected by the first position detection device, by the second position detection device, or by the first position detection device and the second position detection device.

A display apparatus according to a third aspect of the present disclosure for achieving the above object includes:

an eyepiece optical device; and

an image display device including an image forming device and a transfer optical device that emits an image incident from the image forming device to the eyepiece optical device, in which

the eyepiece optical device and the image display device are spatially separated from each other,

the eyepiece optical device forms the image from the transfer optical device on a retina of an observer,

the image display device further includes a first position detection device that detects a position of the eyepiece optical device,

the first position detection device includes

a light source,

a first optical path synthesizing unit,

a second optical path synthesizing unit, and

a light receiving unit,

the image incident from the image forming device is formed on the retina of the observer via the second optical path synthesizing unit, the transfer optical device, and the eyepiece optical device, and

light emitted from the light source reaches the eyepiece optical device via the first optical path synthesizing unit, the second optical path synthesizing unit, and the transfer optical device, is returned to the transfer optical device by the eyepiece optical device, is incident on the first optical path synthesizing unit via the transfer optical device and the second optical path synthesizing unit, is emitted from the first optical path synthesizing unit in a direction different from a direction of the light source, and is incident on the light receiving unit.

### BRIEF DESCRIPTION OF DRAWINGS

FIG. 1 is a conceptual diagram of a display apparatus of a first embodiment.

FIG. 2 is a schematic diagram of an observer as viewed from the front, the observer wearing an eyepiece optical device included in the display apparatus of the first embodiment.

FIGS. 3A, 3B, and 3C are conceptual diagrams of an image forming device in the display apparatus of the first embodiment.

FIG. 4 is a conceptual diagram of position detection light in a light receiving unit.

FIG. 5 is a conceptual diagram of the display apparatus of the first embodiment for describing operation of the display apparatus.

FIG. 6 is a conceptual diagram of the display apparatus of the first embodiment for describing operation of the display apparatus.

FIG. 7 is a conceptual diagram of the display apparatus of the first embodiment for describing operation of the display apparatus.

FIG. 8 is a conceptual diagram of the display apparatus of the first embodiment for describing operation of the display apparatus.

FIG. 9 is a conceptual diagram of the display apparatus of the first embodiment for describing operation of the display apparatus.

FIG. 10 is a conceptual diagram of position detection light in a light receiving unit.

FIG. 11 is a conceptual diagram of position detection light in a light receiving unit.

FIG. 12 is a conceptual diagram of position detection light in a light receiving unit.

FIG. 13 is a conceptual diagram of position detection light in a light receiving unit.

FIGS. 14A, 14B, and 14C schematically illustrate behavior of a luminous flux emitted from a transfer optical device and a positional relationship between an eyepiece optical device and a pupil of an observer, and, in particular, FIG. 14C is an explanatory diagram of an angle θ₁ between a straight line connecting the center of the eyepiece optical device and the center of the pupil of the observer and a normal line passing through the center of the eyepiece optical device and an angle θ₂ between a light beam emitted from the center of an image forming device to reach the eyepiece optical device via the transfer optical device and the normal line passing through the center of the eyepiece optical device.

FIGS. 15A and 15B schematically illustrate behavior of a luminous flux emitted from a transfer optical device and a positional relationship between an eyepiece optical device and a pupil of an observer, which are explanatory diagrams of an angle θ₁ between a straight line connecting the center of the eyepiece optical device and the center of the pupil of the observer and a normal line passing through the center of the eyepiece optical device and an angle θ₂ between a light beam emitted from the center of an image forming device to reach the eyepiece optical device via the transfer optical device and the normal line passing through the center of the eyepiece optical device.

FIG. 16 is a conceptual diagram of a display apparatus of a fourth embodiment.

FIGS. 17A and 17B are schematic diagrams of a state in which the display apparatus of the fourth embodiment is used in a room and an image forming device is disposed on a back surface of a back of a seat.

FIG. 18 is an explanatory diagram of an example where the display apparatus of the fourth embodiment is mounted on a motorcycle.

FIGS. 19A and 19B are conceptual diagrams of a display apparatus of a fifth embodiment and a modification example thereof.

FIGS. 20A and 20B are conceptual diagrams of a display apparatus of a sixth embodiment.

FIG. 21 is a conceptual diagram of a display apparatus of a seventh embodiment.

FIGS. 22A, 22B, 22C, and 22D schematically illustrate behavior of a luminous flux emitted from a transfer optical device and a positional relationship between an eyepiece optical device and a pupil of an observer in a display apparatus of an eighth embodiment.

FIG. 23A is a partial enlarged schematic cross-sectional view of a reflective volume hologram diffraction grating, and FIGS. 23B and 23C are partial schematic cross-sectional views (note that hatching lines are omitted) of a reflective blazed diffraction grating and a reflective blazed diffraction grating having a step shape.

### MODE FOR CARRYING OUT THE INVENTION

Hereinafter, the present disclosure will be described on the basis of embodiments with reference to the drawings, but the present disclosure is not limited to the embodiments, and various numerical values and materials in the embodiments are merely examples. Note that description will be provided in the following order.

1. General description regarding display apparatuses according to first to third aspects of present disclosure

2. First embodiment (display apparatuses according to first to third aspects of the present disclosure)

3. Second embodiment (modification of first embodiment)

4. Third embodiment (another modification of first embodiment)

5. Fourth embodiment (modification of first to third embodiments)

6. Fifth embodiment (modification of fourth embodiment)

7. Sixth embodiment (modification of first to fifth embodiments)

8. Seventh embodiment (modification of first to sixth embodiments)

9. Eighth embodiment (modification of first to seventh embodiments)

10. Others

### General Description Regarding Display Apparatuses According to First to Third Aspects of Present Disclosure

In the following description, a horizontal direction of an image formed on a retina of an observer will also be referred to as an X direction, a vertical direction of the image will also be referred to as a Y direction, and a depth direction of the image will also be referred to as a Z direction. Further, a direction in a transfer optical device corresponding to the X direction will be referred to as an “x direction”, a direction in the transfer optical device corresponding to the Y direction will be referred to as a “y direction”, and a direction in the transfer optical device corresponding to the Z direction will be referred to as a “z direction”. Furthermore, light incident from an image forming device will be referred to as “image forming light” for convenience, light incident from the center of the image forming device will be referred to as “image forming center light” for convenience, light emitted from a light source will be referred to as “position detection light” for convenience, and light emitted from the center of the light source will be referred to as “position detection center light” for convenience.

In a display apparatus according to a first aspect of the present disclosure, a control unit can control formation of an image in an image forming device on the basis of position information of an eyepiece optical device detected by a first position detection device, by a second position detection device, or by the first position detection device and the second position detection device.

In the display apparatus according to the first aspect of the present disclosure having the above-described preferable form or in a display apparatus according to a second aspect of the present disclosure,

the first position detection device can include:

a light source;

a first optical path synthesizing unit;

a second optical path synthesizing unit; and

a light receiving unit,

in which

the image (image forming light) incident from the image forming device can be formed on a retina of an observer via the second optical path synthesizing unit, a transfer optical device, and the eyepiece optical device, and

light (position detection light) emitted from the light source can reach the eyepiece optical device via the first optical path synthesizing unit, the second optical path synthesizing unit, and the transfer optical device, can be returned to the transfer optical device by the eyepiece optical device, can be incident on the first optical path synthesizing unit via the transfer optical device and the second optical path synthesizing unit, can be emitted from the first optical path synthesizing unit in a direction different from a direction of the light source, and can be incident on the light receiving unit. Note that the display apparatus in such a form according to the first aspect of the present disclosure will also be referred to as a “display apparatus according to a 1-A-th aspect of the present disclosure” for convenience, and the display apparatus in such a form according to the second aspect of the present disclosure will also be referred to as a “display apparatus according to a 2-A-th aspect of the present disclosure” for convenience.

In the display apparatus according to the 1-A-th aspect or the 2-A-th aspect of the present disclosure, in a case where an incident position of the light (position detection light) incident on the light receiving unit from the first optical path synthesizing unit shifts from a predetermined position (reference position), a transfer-optical-device control device can control a position of the transfer optical device so as to eliminate the shift.

In the display apparatus having such a preferable configuration according to the 1-A-th aspect or the 2-A-th aspect of the present disclosure or in a display apparatus according to a third aspect of the present disclosure, an emission angle of light (position detection center light) from the transfer optical device, the light having been emitted from the center of the light source, can be different from an emission angle of light (image forming center light) from the transfer optical device, the light having been emitted from the center of the image forming device.

Further, in the display apparatus having the above-described various preferable configurations according to the 1-A-th aspect or the 2-A-th aspect of the present disclosure or in the display apparatus having the above-described preferable configuration according to the third aspect of the present disclosure, the light source can emit infrared rays in an eye-safe wavelength band (e.g. a wavelength around 1.55 μm).

By the way, a position detection resolution can be improved as an amount of the position detection light returning to the light receiving unit increases. Meanwhile, in order to detect a position of the eyepiece optical device, light close to parallel light is emitted toward the vicinity of eyes of the observer. Thus, it is necessary to determine an upper limit of the amount of the position detection light in consideration of safety. An exposure limit for pupils and retinas depends on a wavelength of the position detection light, and an allowable amount of light is the largest in the eye-safe wavelength band. This is because the light in the eye-safe wavelength band has a property of attenuating in the presence of water molecules and does not reach the retinas. For the above reason, it is possible to achieve high safety and high position detection resolution by setting a wavelength band of the position detection light to the eye-safe wavelength band. Further, for a similar reason, the eye-safe wavelength band is also a wavelength band in which an intensity of sunlight near the ground surface is weak. Thus, there is also an advantage that the first position detection device is hardly affected by external light.

Further, in the display apparatus having the above-described various preferable configurations according to the 1-A-th aspect or the 2-A-th aspect of the present disclosure or in the display apparatus having the above-described preferable configuration according to the third aspect of the present disclosure, the light (position detection light) emitted from the light source included in the first position detection device and incident on the first optical path synthesizing unit can be divergent light.

Further, in the display apparatus having the above-described various preferable configurations according to the 1-A-th aspect or the 2-A-th aspect of the present disclosure or in the display apparatus having the above-described various preferable configurations according to the third aspect of the present disclosure, the light receiving unit can be arranged at a position (on an in-focus side) closer to the first optical path synthesizing unit than to a position optically conjugate with the light source. That is, an optical distance from the light receiving unit to the first optical path synthesizing unit (which is a sum total of a product of a spatial distance of a medium and a refractive index of the medium in an optical path of the position detection center light, and a focal length of a lens is also considered in a case where the lens is arranged between the light receiving unit and the first optical path synthesizing unit) is shorter than an optical distance from the light source to the first optical path synthesizing unit (which is a sum total of the product of the spatial distance of the medium and the refractive index of the medium in the optical path of the position detection center light, and the focal length of the lens is also considered in a case where the lens is arranged between the light source and the first optical path synthesizing unit). Further, it is possible to improve foreign matter resistance by arranging the light receiving unit at a position (on the in-focus side) closer to the first optical path synthesizing unit than to a beam waist position (a position where a spot diameter is the smallest) of the position detection light.

Further, in the display apparatus having the above-described various preferable configurations according to the 1-A-th aspect or the 2-A-th aspect of the present disclosure or in the display apparatus having the above-described various preferable configurations according to the third aspect of the present disclosure, the light receiving unit is sorted according to an operation principle into two types, i.e., a non-segmented one and a segmented one. The former is a position sensitive detector that detects a position of the position detection light by applying a change in a surface resistance value of a photodiode. The position of the position detection light is detected by using a principle that the surface resistance value changes according to an amount of light. The latter detects the position of the position detection light by comparing voltages of a plurality of areas (e.g. four areas) into which the photodiode is segmented. The light receiving unit can include a plurality of photodiodes, instead of the area-segmented photodiode. Both are analog outputs, and thus the position detection resolution is theoretically infinitesimal. As described above, the light receiving unit (a device or element that detects the position of the eyepiece optical device) can include the position sensitive detector (PSD), the multi-segmented photodiode, or the plurality of photodiodes.

Examples of the second position detection device include a camera (imaging device), a time of flight (TOF) distance measurement device, and an indirect TOF distance measurement device. Further, the camera can be used to measure a distance from a retroreflective element (described later) on the basis of the size of the retroreflective element or a distance between a plurality of retroreflective elements. The camera can also be used for coarse adjustment for specifying the position of the eyepiece optical device at the start of the use of the display apparatus. That is, at the start of the use of the display apparatus, the position of the eyepiece optical device is searched for by the camera, and the transfer optical device is coarsely adjusted. Then, when the light receiving unit starts receiving the position detection light, the first position detection device only needs to finely adjust the transfer optical device. Alternatively, at the start of the use of the display apparatus, the position of the eyepiece optical device is searched for on the basis of scanning of the transfer optical device, and, when the light receiving unit starts receiving the position detection light, the first position detection device may finely adjust the transfer optical device.

In some cases, the first position detection device also serves as the second position detection device. That is, the light source included in the first position detection device is subjected to intensity modulation at a high frequency, the position detection light colliding with and reflected by the eyepiece optical device is received by the light receiving unit, and a distance from the target (eyepiece optical device) is obtained on the basis of, for example, a phase delay time of a pulse wave. Specifically, the position detection light is modulated on the order of megahertz to gigahertz, and a signal output by the light receiving unit is divided into components, i.e., a high frequency component corresponding to a modulation bandwidth (a bandwidth for detecting the distance from the eyepiece optical device) and a low frequency component of kilohertz or less (a bandwidth for detecting the position of the eyepiece optical device) and is subjected to signal processing. This makes it possible to obtain the position of the eyepiece optical device, without increasing the number of components or the number of retroreflective elements (described later).

Further, in the display apparatuses having the above-described various preferable forms and configurations according to the first to third aspects of the present disclosure, the first position detection device can also serve as the second position detection device.

Further, in the display apparatuses having the above-described various preferable forms and configurations according to the first to third aspects of the present disclosure, the transfer-optical-device control device can cause the transfer optical device to perform image projection control on the retina of the observer in the horizontal direction (X direction) and the vertical direction (Y direction) of the image to be formed on the retina of the observer. That is, the transfer optical device can perform control to move the light (image forming light) directed toward the eyepiece optical device in the x direction or the y direction.

Further, in the display apparatuses having the above-described various preferable forms and configurations according to the first to third aspects of the present disclosure, the transfer optical device can include a movable mirror. Specifically, for example, the transfer optical device can include a combination of two galvanometer mirrors. In order to move the light (image forming light) directed from the transfer optical device toward the eyepiece optical device in the x direction and/or the y direction, the transfer optical device can be not only, for example, the mirror movable in two directions, specifically, the combination of two galvanometer mirrors, but also a two-axis gimbal mirror including a two-axis micro electro mechanical systems (MEMS) mirror.

Further, in the display apparatuses having the above-described various preferable forms and configurations according to the first to third aspects of the present disclosure, position display means (means for being subjected to position detection), specifically, the retroreflective element can be attached to the eyepiece optical device. Specific examples of the retroreflective element include a retroreflective marker including a retroreflective sheet and a corner cube prism. The corner cube prism is a device in which three flat plates having a property of reflecting light are combined at right angles with each other to form a vertex shape of a cube. Because the number of prisms is one, there is no in-plane variation, and reflectance is easily increased. Therefore, there are advantages that an amount of return light can be increased and resolution can be increased. Further, in a case where a corner cube array in which a plurality of small corner cube prisms is arranged is used, it is possible to reduce a thickness of the retroreflective element. This increases a degree of freedom of attachment to the eyepiece optical device.

Further, in the display apparatuses having the above-described various preferable forms and configurations according to the first to third aspects of the present disclosure, the eyepiece optical device can include a hologram element, can include a diffractive optical member, or can include a light collection member and a deflection member. In a case where the eyepiece optical device includes the hologram element, the hologram element may have a light collection function. The image forming light incident from the image forming device is incident on the transfer optical device in a substantially parallel light state and is emitted from the transfer optical device to the eyepiece optical device. The eyepiece optical device is arranged such that a pupil of the observer is located at a focal point of the eyepiece optical device.

The eyepiece optical device can have wavelength dependence on a light collection characteristic for the position detection light. That is, it is preferable that infrared rays forming the position detection light be not affected by the light collection characteristic of the eyepiece optical device or be hardly affected by the light collection characteristic of the eyepiece optical device. For example, in a case where the eyepiece optical device includes the hologram element, it is preferable that the infrared rays forming the position detection light be not collected or be slightly collected by the hologram element. The hologram element can have a known configuration and structure.

The eyepiece optical device is attached to, but not limited to, a support member or is provided in the support member integrally with the support member. In a case where the support member is made from a transparent plastic material, examples of the plastic material include polyethylene terephthalate, polyethylene naphthalate, polycarbonate, cellulose esters such as cellulose acetate, fluoropolymers such as a copolymer of polyvinylidene fluoride or polytetrafluoroethylene and hexafluoropropylene, polyethers such as polyoxymethylene, polyacetals, polystyrenes, polyolefins such as polyethylene, polypropylene, and a methylpentene polymer, polyimides such as polyamideimide and polyetherimide, polyamides, polyethersulfone, polyphenylene sulfide, polyvinylidene fluoride, tetraacetyl cellulose, brominated phenoxy, polyarylate, and polysulfone. In a case where the support member is made from glass, examples of the glass include transparent glass such as soda-lime glass and super white glass.

Further, in the display apparatuses having the above-described various preferable forms and configurations according to the first to third aspects of the present disclosure, the eyepiece optical device and an image display device can be relatively movable. That is, the image display device can be arranged at a position away from the observer or can be arranged at a part of the observer away from a head of the observer. In the latter case, for example, the image display device is worn as a wearable device on a part such as, but not limited to, a wrist of the observer away from the head of the observer. Alternatively, the image display device is arranged in a personal computer or is arranged while being connected to the personal computer. Alternatively, the image display device is disposed in an external facility or the like as described later.

Further, in the display apparatuses having the above-described various preferable forms and configurations according to the first to third aspects of the present disclosure, the eyepiece optical device can be worn by the observer or can be arranged at a position away from the observer (that is, the eyepiece optical device is not worn by the observer).

In the display apparatuses having above-described various preferable forms and configurations according to the first to third aspects of the present disclosure (hereinafter, those will be collectively referred to as a “display apparatus and the like of the present disclosure”), the eyepiece optical device and the image display device are spatially separated from each other. Specifically, the eyepiece optical device and the image display device are arranged separately from each other and are not integrally connected.

In the display apparatus and the like of the present disclosure, the transfer-optical-device control device controls the transfer optical device such that the image incident from the image forming device reaches the eyepiece optical device under the control of the control unit on the basis of the position information of the eyepiece optical device detected by the first position detection device. The transfer optical device can be controlled such that the entire image incident from the image forming device reaches the eyepiece optical device or can also be controlled such that a part of the image incident from the image forming device reaches the eyepiece optical device. The display apparatus and the like of the present disclosure are retinal projection display apparatuses based on the Maxwellian view.

The light (position detection light) emitted from the light source is reflected by the first optical path synthesizing unit and is incident on the second optical path synthesizing unit. Then, in this case, the light (return light) from the second optical path synthesizing unit is transmitted through the first optical path synthesizing unit and is incident on the light receiving unit. Alternatively, the light (position detection light) emitted from the light source is transmitted through the first optical path synthesizing unit and is incident on the second optical path synthesizing unit. Then, in this case, the light (return light) from the second optical path synthesizing unit is reflected by the first optical path synthesizing unit and is incident on the light receiving unit. Examples of the first optical path synthesizing unit having such a function include a polarizing beam splitter. The polarizing beam splitter transmits P-polarized light and reflects S-polarized light. Alternatively, examples of the first optical path synthesizing unit having such a function include a one-way mirror.

The image incident from the image forming device is transmitted through the second optical path synthesizing unit and is incident on the transfer optical device. Meanwhile, the light (position detection light) from the light source is reflected by the second optical path synthesizing unit, reaches the eyepiece optical device via the transfer optical device, is returned to the transfer optical device by the eyepiece optical device, is incident on the second optical path synthesizing unit, is reflected by the second optical path synthesizing unit, and is incident on the first optical path synthesizing unit. Alternatively, the image incident from the image forming device is reflected by the second optical path synthesizing unit, and the light (position detection light) from the light source is transmitted through the second optical path synthesizing unit, reaches the eyepiece optical device via the transfer optical device, is returned to the transfer optical device by the eyepiece optical device, is incident on the second optical path synthesizing unit, is transmitted through the second optical path synthesizing unit, and is incident on the first optical path synthesizing unit. Examples of the second optical path synthesizing unit having such a function include a one-way mirror, a dichroic mirror that reflects light of a specific wavelength and transmits light of other wavelengths, and a cold mirror that reflects only visible light and transmits infrared light.

A relationship among the first optical path synthesizing unit, the second optical path synthesizing unit, the image forming light, and the position detection light is summarized in Tables 1, 2, 3, and 4 below.

TABLE 1

| | | First optical path | Second optical path |
|---|---|---|---|
| Wavelength | | synthesizing unit | synthesizing unit |
| Image | near 450 nm | — | transmitted |
| forming | near 520 nm | — | transmitted |
| light | near 640 nm | — | transmitted |
| Position | near 1550 nm | forward path: | forward path: |
| detection | | reflected | reflected |
| light | | return path: | return path: |
| | | transmitted | reflected |

TABLE 2

| | | First optical path | Second optical path |
|---|---|---|---|
| Wavelength | | synthesizing unit | synthesizing unit |
| Image | near 450 nm | — | transmitted |
| forming | near 520 nm | — | transmitted |
| light | near 640 nm | — | transmitted |
| Position | near 1550 nm | forward path: | forward path: |
| detection | | transmitted | reflected |
| light | | return path: | forward path: |
| | | reflected | reflected |

TABLE 3

| | | First optical path | Second optical path |
|---|---|---|---|
| Wavelength | | synthesizing unit | synthesizing unit |
| Image | near 450 nm | — | reflected |
| forming | near 520 nm | — | reflected |
| light | near 640 nm | — | reflected |
| Position | near 1550 nm | forward path: | forward path: |
| detection | | reflected | transmitted |
| light | | return path: | return path: |
| | | transmitted | transmitted |

TABLE 4

| | | First optical path | Second optical path |
|---|---|---|---|
| Wavelength | | synthesizing unit | synthesizing unit |
| Image | near 450 nm | — | reflected |
| forming | near 520 nm | — | reflected |
| light | near 640 nm | — | reflected |
| Position | near 1550 nm | forward path: | forward path: |
| detection | | transmitted | transmitted |
| light | | return path: | return path: |
| | | reflected | transmitted |

Further, in the display apparatus and the like of the present disclosure having the above-described preferable form and configuration, the light source can emit infrared rays as described above, but is not limited to this configuration, and may receive visible light having a predetermined wavelength. Note that, in the former case (a mode in which infrared rays are emitted), the light source can include, for example, a light emitting diode that emits infrared rays, a semiconductor laser element that emits infrared rays, or a combination of a semiconductor laser element that emits infrared rays and a light diffusion plate. Further, the light receiving unit can be not only the non-segmented or segmented light receiving unit described above but also a light receiving unit including an imaging device (infrared camera) or a sensor (infrared sensor) capable of detecting infrared rays. A filter (infrared transmitting filter) that passes only a wavelength of infrared rays used for detection is provided ahead of the imaging device. This can simplify image processing in a subsequent stage. Meanwhile, in the latter case (a mode in which visible light having a predetermined wavelength is received), the light receiving unit can include an imaging device (camera) or sensor (image sensor) capable of detecting visible light. Further, in the latter case (the mode in which visible light having the predetermined wavelength is received), the eyepiece optical device can have wavelength dependence on a light collection characteristic. Furthermore, the eyepiece optical device can include a lens member or can include a hologram element. Still further, in some cases, the imaging device (camera) or sensor included in the light receiving unit can specify the position of the eyepiece optical device by performing image processing on an obtained image of the eyepiece optical device. Although the retroreflective element is unnecessary, the image processing can be simplified by attaching, for example, a color marker to the eyepiece optical device.

In a case where the position detection light emitted from the light source is incident on the first optical path synthesizing unit via a coupling lens arranged adjacent to the light source in order to convert the light to be incident on the first optical path synthesizing unit into parallel light, it is necessary to make all optical elements (including not only the first optical path synthesizing unit, the second optical path synthesizing unit, and the transfer optical device, but also the coupling lens) through which the position detection light passes larger than a spot size of the position detection light in the eyepiece optical device. Specifically, it is necessary to design the size of the coupling lens in consideration of the size of the retroreflective element, a margin at the time of various operations, and a shift of an advancing axis which may occur within an expected moving range of the observer. This makes it difficult to reduce the entire size of the display apparatus in some cases. By arranging the light source inside a focal point position of the coupling lens, the light (position detection light) emitted from the light source becomes divergent light as described above. This makes it possible to reduce the entire size of the display apparatus. Further, in an optical design, it is desirable to reduce an optical path length (a distance from the light source to the transfer optical device) in a main body as much as possible from the viewpoint of size reduction.

The display apparatus and the like of the present disclosure may include a known eye tracking device (eye tracking camera). For example, the eye tracking device generates a reflection point of light (e.g. near infrared ray) on a cornea, captures an image of the reflection point, recognizes the reflection point of the light on the cornea and the pupil from the captured image of an eyeball, and calculates a direction of the eyeball on the basis of the reflection point of the light and other geometric features. Further, a pupil diameter measurement unit that measures a pupil diameter of the observer may be provided. Examples of the pupil diameter measurement unit include a known eye tracking device (eye tracking camera). Specifically, it is possible to calculate a distance from the eye tracking device to the pupil on the basis of the image of the eye recorded by the eye tracking device and obtain the pupil diameter on the basis of a diameter of the pupil in the captured image. By obtaining the pupil diameter, it is possible to control luminance of the image and optimize incidence of the image on the pupil.

Further, in the display apparatus and the like of the present disclosure having the above-described preferable form and configuration, when an angle between a straight line connecting the center of the eyepiece optical device and the center of the pupil of the observer and a normal line passing through the center of the eyepiece optical device is denoted by θ₁, an angle between a light beam emitted from the center of the image forming device to reach the eyepiece optical device via the transfer optical device and the normal line passing through the center of the eyepiece optical device is denoted by θ₂, and a focal length of the eyepiece optical device is denoted by f₀ (unit: mm), the pupil diameter of the observer strongly depends on an environment and a state of the observer and is said to be 2 mm to 7 mm.

Therefore, the transfer-optical-device control device can control the transfer optical device so as to satisfy

f₀·|tan(θ₂)−tan(θ₁)|≤3.5

preferably,

f₀·|tan(θ₂)−tan(θ₁)|≤1,

and more preferably θ₁=θ₂.

Further, in the display apparatus and the like of the present disclosure having the above-described preferable form and configuration, the eyepiece optical device can include a diffraction grating. The diffraction grating is an optical element that causes a diffraction phenomenon by a grating pattern. A plurality of images is obtained on the basis of a k-th order diffracted light (where k=0, ±1, ±2 . . . ) emitted from the diffraction grating. Note that, when an image formed by parallel light is incident on the diffraction grating, light beams forming each image emitted from the diffraction grating also become parallel light.

Examples of the diffraction grating included in the eyepiece optical device include, but are not limited to, a transmission diffraction grating, a transmission hologram diffraction grating (specifically, a transmission volume hologram diffraction grating), a reflective diffraction grating, a reflective hologram diffraction grating (specifically, a reflective volume hologram diffraction grating). In a case where the diffraction grating includes the transmission diffraction grating or the transmission hologram diffraction grating and an incident angle ψ of light forming an image is constant, it is necessary to variously change a value of Θ in order to obtain a plurality of images divided by and emitted from the diffraction grating. In order to change the value of Θ, a value of an inclination angle φ may be changed on the basis of Expression (B), or a value of a pitch d of a grating surface may be changed on the basis of Expression (A). In other words, by appropriately selecting the value of the inclination angle φ and the value of the pitch d of the grating surface, it is possible to divide an image incident on the diffraction grating including the volume hologram diffraction grating by using the diffraction grating and emit a plurality of images from the diffraction grating.

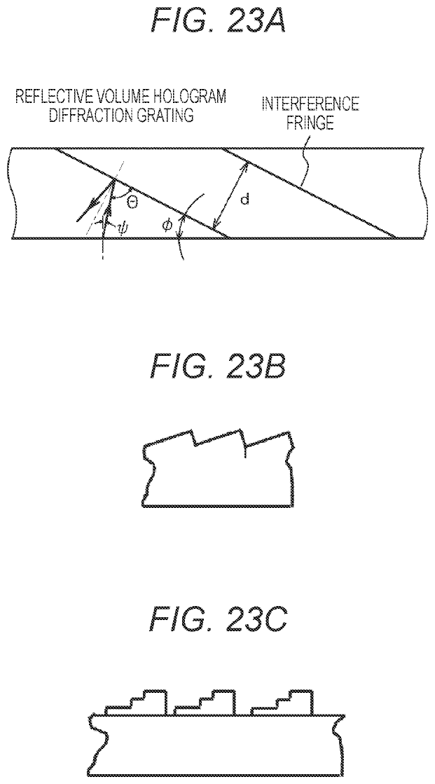

Alternatively, the diffraction grating can have a known configuration and structure, and examples thereof include a reflective blazed diffraction grating (see FIG. 23B) and a reflective blazed diffraction grating having a step shape (see FIG. 23C), but are not limited to those diffraction gratings. The grating pattern is configured such that, for example, linear projections and recesses are arranged in parallel at a micrometer-sized cycle, and the cycle, a pattern thickness (a difference in thickness between the projections and recesses), and the like are appropriately selected on the basis of a wavelength band of the light emitted from the image forming device. The diffraction grating can be manufactured by a known method.

The image can be divided into at least two images by the diffraction grating included in the eyepiece optical device. Specifically, for example, the image can be divided by the diffraction grating into three images in the horizontal direction, into three images in the vertical direction, into three images in the horizontal direction and three images in the vertical direction in the shape of a cross (into five images in total because images having a center light path overlap with each other), into two images in the horizontal direction and two images in the vertical direction, i.e., 2×2=4, and into three images in the horizontal direction and three images in the vertical direction, i.e., 3×3=9.

In the display apparatus and the like of the present disclosure having the above-described preferable form and configuration, the eyepiece optical device can be a semi-transmission (see-through) device. This makes it possible to view the outside through the eyepiece optical device. Further, in this case, the eyepiece optical device can be formed by a hologram element or can include a hologram element. In some cases, the eyepiece optical device can also be a non-transmission device (a mode in which the outside cannot be viewed through the eyepiece optical device).

In the display apparatus and the like of the present disclosure having the above-described preferable form and configuration, the image display device can be arranged ahead of the observer. Note that, although depending on specifications of the transfer optical device and the eyepiece optical device, the image display device may be located at a position higher than the head of the observer, may be located at the same level as the head of the observer, may be located at a position lower than the head of the observer, may be located to face the observer, or may be located obliquely to the observer as long as the image display device is arranged ahead of the observer. In a case of the non-transmission display apparatus, the image display device can also be arranged in front of the observer.

In the display apparatus and the like of the present disclosure having the above-described preferable form and configuration, the image forming device can have a plurality of pixels arrayed in a two-dimensional matrix. The image forming device having such a configuration will be referred to as an “image forming device having a first configuration” for convenience.

Examples of the image forming device having the first configuration include an image forming device including a reflective spatial light modulation device and a light source; an image forming device including a transmission spatial light modulation device and a light source; and an image forming device including a light emitting element such as an organic electro luminescence (EL), an inorganic EL, a light emitting diode (LED), or a semiconductor laser element. Among them, the image forming device including an organic EL light emitting element (organic EL display device) and the image forming device including a reflective spatial light modulation device and a light source are preferable. Examples of the spatial light modulation device include a light valve, for example, a transmission or reflective liquid crystal display device such as liquid crystal on silicon (LCOS) and a digital micromirror device (DMD). Examples of the light source include a light emitting element. Further, the reflective spatial light modulation device can include a liquid crystal display device and a polarizing beam splitter that reflects a part of light from the light source to guide the reflected light to the liquid crystal display device and passes a part of the light reflected by the liquid crystal display device to guide the passed light to the transfer optical device. Examples of the light emitting element included in the light source include a red light emitting element, a green light emitting element, a blue light emitting element, and a white light emitting element. Alternatively, white light may be obtained by mixing red light, green light, and blue light emitted from the red light emitting element, the green light emitting element, and the blue light emitting element by using a light pipe and uniformizing luminance. Examples of the light emitting element include a semiconductor laser element, a solid-state laser, and an LED. The number of pixels only needs to be determined on the basis of specifications required for the image forming device. Examples of a specific value of the number of pixels include 320×240, 432×240, 640×480, 1024×768, and 1920×1080. In the image forming device having the first configuration, a diaphragm can be arranged at a front focal point (a focal point on the image forming device side) position in a lens system (described later).

Alternatively, the image forming device in the display apparatus and the like of the present disclosure having the above-described preferable form and configuration can include a light source and scanning means for scanning light emitted from the light source and forming an image. The image forming device having such a configuration will be referred to as an “image forming device having a second configuration” for convenience.

Examples of the light source in the image forming device having the second configuration include a light emitting element. Specifically, examples thereof include a red light emitting element, a green light emitting element, a blue light emitting element, and a white light emitting element. Alternatively, white light may also be obtained by mixing red light, green light, and blue light emitted from the red light emitting element, the green light emitting element, and the blue light emitting element by using a light pipe and uniformizing luminance. Examples of the light emitting element include a semiconductor laser element, a solid-state laser, and an LED. The number of pixels (virtual pixels) in the image forming device having the second configuration also only needs to be determined on the basis of the specifications required for the image forming device. Examples of a specific value of the number of pixels (virtual pixels) include 320×240, 432×240, 640×480, 1024×768, and 1920×1080. Further, in a case where a color image is displayed and the light source includes a red light emitting element, a green light emitting element, and a blue light emitting element, it is preferable to perform color synthesis by using, for example, a crossed prism. Examples of the scanning means include a MEMS mirror and a galvanometer mirror which include a micromirror rotatable in a two-dimensional direction and horizontally and vertically scan light emitted from the light source. In the image forming device having the second configuration, a MEMS mirror or galvanometer mirror can be arranged at the front focal point (the focal point on the image forming device side) position in the lens system (described later).

In the image forming device having the first configuration or the image forming device having the second configuration, light converted into a plurality of parallel light beams by the lens system (an optical system that converts emitted light into parallel light) is caused to be incident on the transfer optical device (specifically, for example, a movable mirror). In order to generate parallel light, specifically, a light emitting portion of the image forming device only needs to be located at a place (position) of a focal length in the lens system as described above, for example. Examples of the lens system include an optical system having positive optical power as a whole in which a convex lens, a concave lens, a freeform surface prism, and a hologram lens are used alone or in combination. A light shielding portion having an opening may be arranged in the vicinity of the lens system between the lens system and the transfer optical device so that undesirable light is not emitted from the lens system and incident on the transfer optical device.

In the display apparatus and the like of the present disclosure, the eyepiece optical device can be attached to a frame. The frame includes a front arranged in front of the observer, two temples rotatably attached to both ends of the front via hinges, and a nose pad. A temple tip is attached to a tip end of each temple. Further, the front and the two temples can be integrated. An assembly of the frame (including a rim) and the nose pad has substantially the same structure as normal eyeglasses. A material of the frame including the nose pad can be the same as a material of normal eyeglasses, such as metal, alloy, plastic, or a combination thereof. Alternatively, the eyepiece optical device can be attached to goggles or a face mask, can be integrally formed with goggles or a face mask, or can be attached to a surface member (a face member, a mask member) having a shape similar to that of a disaster prevention surface that can be mounted on the head of the observer, or can also be integrally formed with the surface member.

The eyepiece optical device to be worn by the observer has an extremely simple structure and does not require a battery or the like for driving because no drive unit is provided. This makes it possible to easily reduce the size and weight of the eyepiece optical device. Unlike conventional HMDs, the image display device is not mounted on the head of the observer. The image display device is disposed in an external facility or the like or is worn as a wearable device on the wrist or the like of the observer. Examples where the image display device is disposed in the external facility or the like include:

(A) an example where the image display device for passengers is attached to a back surface of a back (backrest) of a seat of a vehicle or airplane;

(B) an example where the image display device for spectators is attached to a back surface of a back (backrest) of a seat of a theater or the like;

(C) an example where the image display device for drivers or the like is attached to a vehicle, airplane, automobile, motorcycle, bicycle, or the like;

(D) an example where the image display device is attached to a drone (including a blimp drone) or autonomous agent robot (including an arm robot) capable of maintaining a certain distance from the observer;

(E) an example where the image display device is used as an alternative to a monitor used in a personal computer, mobile phone, smartwatch, or the like;

(F) an example where the image display device is used as an alternative to a display or touchscreen used in an automatic teller machine in a financial institution;

(G) an example where the image display device is used as an alternative to a display or touchscreen used in a store or office;

(H) an example where a screen of a mobile phone or personal computer is displayed in an enlarged or expanded manner;

(I) an example where the image display device is used as an alternative to a display plate or the like used in an art museum, amusement park, or the like;

(J) an example where the image display device for customers is attached to a table of a coffee shop, cafe, or the like; and

(K) an example where the image display device is incorporated into a full-face helmet, protective face mask, or the like.

In the display apparatus and the like of the present disclosure having the above-described various preferable forms and configurations, a signal for displaying an image in the image forming device (a signal for forming a virtual image in the eyepiece optical device) can be received from the outside (outside a system of the display apparatus). In such a form, information and data regarding the image to be displayed on the image forming device are recorded, stored, and saved in, for example, a so-called cloud computer or server. In a case where the image forming device includes communication means such as a telephone line, an optical line, a mobile phone, or a smartphone, or in a case where the image forming device and the communication means are combined, it is possible to transmit/receive and exchange various kinds of information and data between the cloud computer or server and the image display device, and it is also possible to receive a signal based on the various kinds of information and data, that is, a signal for displaying the image on the image forming device. Alternatively, the signal for displaying the image on the image forming device can be stored in the image display device. The image to be displayed on the image forming device includes various kinds of information and various kinds of data. The image display device serving as a wearable device can also include a camera (imaging device). An image captured by the camera may be transmitted to the cloud computer or server via the communication means, various kinds of information and data corresponding to the image captured by the camera may be searched for in the cloud computer or server, the various kinds of information and data thus searched for may be transmitted to the image display device via the communication means, and the various kinds of information and data thus searched for may be displayed on the image forming device.

The display apparatus and the like of the present disclosure having the above-described various forms and configurations can be used for, for example: displaying various kinds of information and the like at various websites on the Internet; displaying various explanations, signs, symbols, marks, symbol marks, designs, and the like at the time of, for example, driving, operating, maintaining, or disassembling an observation target such as various devices; displaying various explanations, signs, symbols, marks, symbol marks, designs, and the like regarding an observation target such as a person or an article; displaying a moving image and a still image; displaying subtitles of a movie and the like; displaying explanations and closed captions regarding video in synchronization with the video; and displaying various explanations regarding an observation target in a play, Kabuki, Noh, Kyogen, opera, concert, ballet, various dramas, amusement park, art museum, sightseeing spot, resort, tourist information, or the like and explanations and the like for explaining content, a progress state, a background, and the like thereof or displaying closed captions. In the play, Kabuki, Noh, Kyogen, opera, concert, ballet, various dramas, amusement park, art museum, sightseeing spot, resort, tourist information, and the like, characters serving as an image related to the observation target only needs to be displayed on the image forming device at an appropriate timing. Specifically, for example, an image control signal is transmitted to the image forming device in response to an operation by an operator or under the control of a computer or the like on the basis of a predetermined schedule and time allocation in accordance with a progress state of a movie or the like or in accordance with a progress state of the play or the like, and an image is displayed on the image forming device. Further, various explanations regarding the observation targets such as various devices, a person, or an article are displayed. By imaging (capturing an image of) the observation target such as the various devices, the person, or the article with the camera and analyzing the imaged (captured) content, it is possible to display the various explanations regarding the observation target such as the person or the article, which have been created in advance, on the image forming device.

### First Embodiment

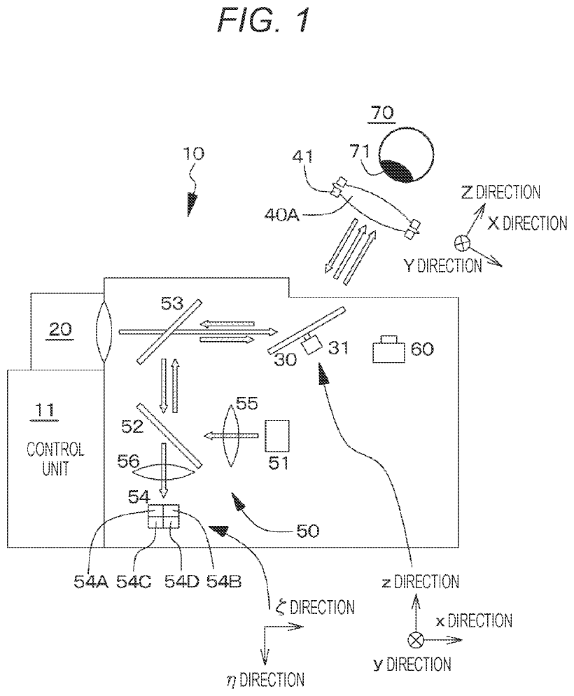

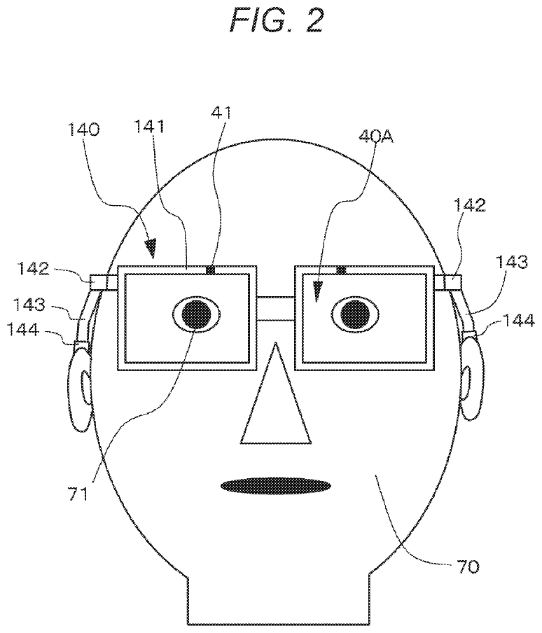

A first embodiment relates to the display apparatuses according to the first to third aspects of the present disclosure. FIG. 1 is a conceptual diagram of a display apparatus according to the first embodiment. FIG. 2 is a schematic diagram of an observer as viewed from the front, the observer wearing an eyepiece optical device included in the display apparatus of the first embodiment.

In a case where the display apparatus in the first embodiment or in second to eighth embodiments described later is expressed according to the display apparatuses in the first and second aspects of the present disclosure, the display apparatus includes:

an eyepiece optical device 40A; and

an image display device 10 including an image forming device 20 and a transfer optical device 30 that emits an image incident from the image forming device 20 to the eyepiece optical device 40A, in which

the eyepiece optical device 40A and the image display device 10 are spatially separated from each other,

the eyepiece optical device 40A forms the image from the transfer optical device 30 on a retina of an observer 70, and

the image display device 10 further includes

a control unit 11,

a first position detection device 50 and a second position detection device 60 that detect a position of the eyepiece optical device 40A, and

a transfer-optical-device control device 31.

Alternatively, in a case where the display apparatus in the first embodiment or in the second to eighth embodiments described later is expressed according to the display apparatus of the third aspect of the present disclosure, the display apparatus includes:

an eyepiece optical device 40A; and

an image display device 10 including an image forming device 20 and a transfer optical device 30 that emits an image incident from the image forming device 20 to the eyepiece optical device 40A, in which

the eyepiece optical device 40A and the image display device 10 are spatially separated from each other,

the eyepiece optical device 40A forms the image from the transfer optical device 30 on a retina of an observer 70,

the image display device 10 further includes a first position detection device 50 that detects a position of the eyepiece optical device 40A, and

the first position detection device 50 includes

a light source 51,

a first optical path synthesizing unit 52,

a second optical path synthesizing unit 53, and

a light receiving unit 54.

Further, in a case where the display apparatus in the first embodiment or the second to eighth embodiments described later is expressed according to the display apparatus in the third aspect of the present disclosure or is expressed according to a preferable form of the display apparatuses in the first and second aspects of the present disclosure,

the image (image forming light) incident from the image forming device 20 is formed on the retina of the observer 70 via the second optical path synthesizing unit 53, the transfer optical device 30, and the eyepiece optical device 40A, and

light (position detection light) emitted from the light source 51 reaches the eyepiece optical device 40A via the first optical path synthesizing unit 52, the second optical path synthesizing unit 53, and the transfer optical device 30, is returned to the transfer optical device 30 by the eyepiece optical device 40A, is incident on the first optical path synthesizing unit 52 via the transfer optical device 30 and the second optical path synthesizing unit 53, is emitted from the first optical path synthesizing unit 52 in a direction different from a direction of the light source 51, and is incident on the light receiving unit 54.

Further, in a case where the display apparatus in the first embodiment or the second to eighth embodiments described later is expressed according to the display apparatus in the first aspect of the present disclosure, the transfer-optical-device control device 31 controls the transfer optical device 30 such that the image incident from the image forming device 20 reaches the eyepiece optical device 40A under the control of the control unit 11 on the basis of position information of the eyepiece optical device 40A detected by the first position detection device 50, and the control unit 11 corrects a position detected by the first position detection device 50 on the basis of position information of the eyepiece optical device 40A detected by the second position detection device 60.

Further, in a case where the display apparatus in the first embodiment or the second to eighth embodiments described later is expressed according to the display apparatus in the second aspect of the present disclosure or is expressed according to a preferable form of the display apparatus in the first aspect of the present disclosure, the transfer-optical-device control device 31 controls the transfer optical device 30 such that the image incident from the image forming device 20 reaches the eyepiece optical device 40A under the control of the control unit 11 on the basis of the position information of the eyepiece optical device 40A detected by the first position detection device 50, and the control unit 11 controls formation of the image in the image forming device 20 on the basis of the position information of the eyepiece optical device 40A detected by the first position detection device 50, by the second position detection device 60, or by the first position detection device 50 and the second position detection device 60.

The light (position detection light) emitted from the light source 51 is reflected by the first optical path synthesizing unit 52 and is incident on the second optical path synthesizing unit 53. Meanwhile, the light (return light) from the second optical path synthesizing unit 53 is transmitted through the first optical path synthesizing unit 52 and is incident on the light receiving unit 54.

In the display apparatus in the first embodiment or the second to eighth embodiments described later, the light source 51 emits infrared rays in an eye-safe wavelength band (e.g. a wavelength around 1.55 μm) which do not interfere with the image. Specifically, the light source 51 includes a semiconductor laser element that emits infrared rays. Further, the light emitted from the light source 51 and incident on the first optical path synthesizing unit 52 is divergent light. A coupling lens 55 is arranged between the light source 51 and the first optical path synthesizing unit 52. The light source 51 is arranged inside a focal point position of the coupling lens 55. Therefore, the light emitted from the light source 51 becomes divergent light. This makes it possible to reduce the entire size of the display apparatus. Further, the first optical path synthesizing unit 52 can include a beam splitter, and the second optical path synthesizing unit 53 can include a dichroic mirror. The infrared rays (position detection light) emitted from the light source 51 do not interfere with the image.

The light receiving unit 54 includes, but is not limited to, a plurality of photodiodes and detects a position of the position detection light by comparing voltages of the plurality of photodiodes (specifically, four diodes 54A, 54B, 54C, and 54D). A lens member 56 is arranged between the light receiving unit 54 and the first optical path synthesizing unit 52. Further, the light receiving unit 54 is arranged at a position (on an in-focus side) closer to the first optical path synthesizing unit 52 than to a position optically conjugate with the light source 51. That is, the light receiving unit 54 is arranged closer to the first optical path synthesizing unit than to a beam waist position (a position where a spot diameter is the smallest) of the position detection light. This makes it possible to improve the foreign matter resistance.

The second position detection device 60 includes a camera, a TOF distance measurement device, or an indirect TOF distance measurement device. The TOF distance measurement device irradiates the eyepiece optical device 40A with pulsed light and detects a time delay when this light travels to and returns from the eyepiece optical device 40A. Further, the indirect TOF distance measurement device irradiates the eyepiece optical device 40A with pulsed light and detects, as a phase difference, a time delay when this light travels to and returns from the eyepiece optical device 40A.

In the indirect TOF method, it is not always necessary to directly convert a change in received light intensity into an electric signal, and it is possible to perform synchronous detection on a sensor (to detect an amount of phase shift as an amount of charge). More specifically, the distance measurement device captures an image of the eyepiece optical device 40A on the basis of light emitted from a light source of the distance measurement device under the control of a control circuit provided in the distance measurement device in a first period TP₁ and a second period TP₂, accumulates first image signal charge obtained by a light receiving device of the distance measurement device in a first charge accumulation unit in the first period TP₁, and accumulates second image signal charge obtained by the light receiving device of the distance measurement device in a second charge accumulation unit in the second period TP₂. Then, the control circuit obtains a distance from the distance measurement device to the eyepiece optical device 40A on the basis of the first image signal charge accumulated in the first charge accumulation unit and the second image signal charge accumulated in the second charge accumulation unit. Here, assuming that the first image signal charge is denoted by Q₁, the second image signal charge is denoted by Q₂, speed of light is denoted by c, and a time (pulse width) in the first period TP₁ and the second period TP₂ is denoted by T_{P}, a distance D from the distance measurement device to the eyepiece optical device 40A can be obtained on the basis of the following expression.

D=(c·T_{P}/2)×Q₂/(Q₁+Q₂)

The transfer optical device 30 includes a movable mirror. The transfer optical device 30 is attached to the transfer-optical-device control device 31 that controls movement of the transfer optical device 30, and the transfer-optical-device control device 31 is controlled by the control unit 11. The transfer optical device 30 includes a combination of two galvanometer mirrors, i.e., a galvanometer mirror that moves light (image forming light and position detection light) incident on the transfer optical device 30 in the x direction and a galvanometer mirror that moves the light in the y direction. However, the present disclosure is not limited thereto.

In the first embodiment, the eyepiece optical device 40A includes a known hologram element. Further, in the display apparatus of the first embodiment, position display means 41 (means for being subjected to position detection), specifically, a retroreflective element, more specifically, but not limited to, a retroreflective marker is fixed to the eyepiece optical device 40A. The retroreflective marker is a light reflective component manufactured such that incident light and reflected light are in the same direction. By using this characteristic, in principle, the return light always returns to the transfer optical device 30 even if the observer 70 moves. As a result, it is possible to detect a position of the retroreflective marker, regardless of a relative positional relationship between the transfer optical device 30 and the retroreflective marker. The retroreflective marker is desirably in a camouflage color with respect to a frame 140. Note that, in a case where wavelength selectivity is given to the position display means 41, specifically, in a case where the position display means 41 has a configuration or structure that reflects the position detection light and transmits other light, the position display means 41 may be attached to or formed in the hologram element included in the eyepiece optical device 40A.

The eyepiece optical device 40A can be worn by the observer 70. Specifically, the eyepiece optical device 40A is attached to the frame 140 (e.g. eyeglass-type frame 140) mounted on a head of the observer 70. More specifically, the eyepiece optical device 40A is fitted into a rim provided in a front 141. The frame 140 includes the front 141 arranged in front of the observer 70, two temples 143 rotatably attached to both ends of the front 141 via hinges 142, and temple tips (also called ear pads) 144 attached to tip ends of the respective temples 143. Further, a nose pad 140′ is attached thereto. An assembly of the frame 140 and the nose pad 140′ basically has substantially the same structure as normal eyeglasses.

In the image display device of the first embodiment or the second to eighth embodiments described later, light emitted from the display apparatus at a certain moment (corresponding to, for example, the size of one pixel or one sub-pixel) reaches a pupil 71 (specifically, a crystalline lens) of the observer 70, and the light passing through the crystalline lens finally forms an image on the retina of the observer 70.

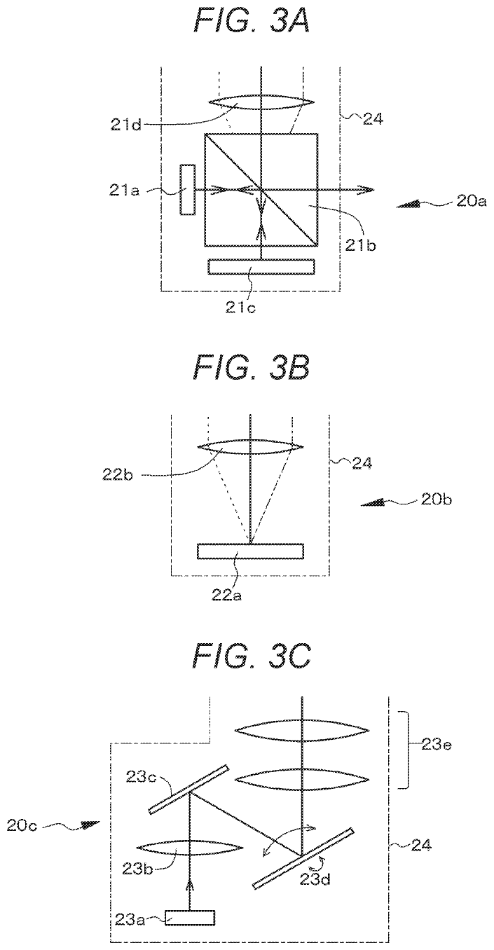

As illustrated in FIG. 3A, the image forming device 20 (hereinafter, the image forming device in FIG. 3A will be referred to as an image forming device 20a) is the image forming device having the first configuration and includes a plurality of pixels arrayed in the two-dimensional matrix. Specifically, the image forming device 20a includes a reflective spatial light modulation device and a light source 21a including a light emitting diode that emits white light. Each entire image forming device 20a is housed in a housing 24 (indicated by a long dashed short dashed line in FIG. 3A), and an opening (not illustrated) is provided in the housing 24. Light is emitted from an optical system 21d (parallel light emitting optical system and collimating optical system) through the opening. The reflective spatial light modulation device includes a liquid crystal display device (LCD) 21c including LCOS as a light valve. Further, the reflective spatial light modulation device includes a polarizing beam splitter 21b that reflects a part of light from the light source 21a to guide the reflected light to the liquid crystal display device 21c and passes a part of the light reflected by the liquid crystal display device 21c to guide the passed light to the optical system 21d. The liquid crystal display device 21c includes a plurality of (e.g. 21d0×480) pixels (liquid crystal cells, liquid crystal display elements) arrayed in the two-dimensional matrix. The polarizing beam splitter 21b has a known configuration and structure. Unpolarized light emitted from the light source 21a collides with the polarizing beam splitter 21b. In the polarizing beam splitter 21b, a P-polarized component passes therethrough and is emitted to the outside of the system. Meanwhile, an S-polarized component is reflected by the polarizing beam splitter 21b, is incident on the liquid crystal display device 21c, is reflected inside the liquid crystal display device 21c, and is emitted from the liquid crystal display device 21c. Here, of the light emitted from the liquid crystal display device 21c, light emitted from a pixel displaying “white” contains a large amount of P-polarized components, and light emitted from a pixel displaying “black” contains a large amount of S-polarized components. Therefore, the P-polarized components of the light emitted from the liquid crystal display device 21c to collide with the polarizing beam splitter 21b pass through the polarizing beam splitter 21b and are guided to the optical system 21d. Meanwhile, the S-polarized components are reflected by the polarizing beam splitter 21b and are returned to the light source 21a. The optical system 21d includes, for example, a convex lens, and, in order to generate parallel light, the image forming device 20a (more specifically, the liquid crystal display device 21c) is arranged at a place (position) of a focal length of the optical system 21d. An image emitted from the image forming device 20a reaches the retina of the observer 70 via the transfer optical device 30 and the eyepiece optical device 40A.

Alternatively, as illustrated in FIG. 3B, the image forming device 20 (hereinafter, the image forming device in FIG. 3B will be referred to as an image forming device 20b) includes an organic EL display device 22a. An image emitted from the organic EL display device 22a passes through a convex lens 22b, becomes parallel light, and reaches the retina of the observer 70 via the transfer optical device 30 and the eyepiece optical device 40A. The organic EL display device 22a includes a plurality of (e.g. 640×480) pixels (organic EL elements) arrayed in the two-dimensional matrix.

Alternatively, as illustrated in FIG. 3C, the image forming device 20 (hereinafter, the image forming device in FIG. 3C will be referred to as an image forming device 20c), which is the image forming device having the second configuration, includes

a light source 23a,

a collimating optical system 23b that converts light emitted from the light source 23a into parallel light,

scanning means 23d that scans the parallel light emitted from the collimating optical system 23b, and

a relay optical system 23e that relays and emits the parallel light scanned by the scanning means 23d. Note that the entire image forming device 20c is housed in the housing 24 (indicated by a long dashed short dashed line in FIG. 3C), and an opening (not illustrated) is provided in the housing 24. Light is emitted from the relay optical system 23e through the opening. The light source 23a includes a light emitting element, specifically, a light emitting diode or a semiconductor laser element. Further, light emitted from the light source 23a is incident on the collimating optical system 23b having positive optical power as a whole and is emitted as parallel light. Then, the parallel light is reflected by a total reflection mirror 23c, is horizontally scanned and vertically scanned by the scanning means 23d including MEMS capable of rotating a micromirror in a two-dimensional direction and two-dimensionally scanning incident parallel light, and is formed into a kind of two-dimensional image. Thus, virtual pixels (the number of pixels can be, for example, the same as that of the image forming device 20a) are generated. Then, the light from the virtual pixels passes through the relay optical system (parallel light emitting optical system) 23e including a known relay optical system, and the image emitted from the image forming device 20c reaches the retina of the observer 70 via the transfer optical device 30 and the eyepiece optical device 40A. In a case where the light source 23a includes a red light emitting element, a green light emitting element, and a blue light emitting element, the observer 70 can detect a color image, whereas, in a case where the light source 23a includes one kind of light emitting element, the observer 70 can detect a monochromatic image.

As described above, an image generated by the image forming device 20 is incident on the transfer optical device (specifically, the movable mirror) 30 in a state of parallel light (or substantially parallel light), is reflected by the transfer optical device 30, and then becomes a luminous flux directed toward the eyepiece optical device 40A. The eyepiece optical device 40A is arranged such that the pupil of the observer 70 is located at a position of the focal point (focal length f₀) of the eyepiece optical device 40A. The projected luminous flux is collected by the eyepiece optical device 40A, passes through the pupil of the observer 70, and is directly drawn on the retina. Therefore, the observer 70 can recognize the image.

In the display apparatus of the first embodiment or the second to eighth embodiments described later, the transfer-optical-device control device 31 causes the transfer optical device 30 to perform image projection control on the retina of the observer 70 in the horizontal direction (X direction) and/or the vertical direction (Y direction) of the image to be formed on the retina of the observer 70. That is, the transfer optical device 30 performs control to move the light directed toward the eyepiece optical device 40A in the x direction or the y direction. Then, the transfer-optical-device control device 31 controls the transfer optical device 30 such that the image incident from the image forming device 20 reaches the eyepiece optical device 40A under the control of the control unit 11 on the basis of the position information of the eyepiece optical device 40A detected by the first position detection device 50. The transfer optical device 30 can be controlled such that the entire image incident from the image forming device 20 reaches the eyepiece optical device 40A or can also be controlled such that a part of the image incident from the image forming device 20 reaches the eyepiece optical device 40A. The display apparatus in the first embodiment or the second to eighth embodiments described later is a retinal projection display apparatus based on the Maxwellian view.

In the display apparatus of the first embodiment or the second to eighth embodiments described later, in a case where an incident position of the light (return light) incident on the light receiving unit 54 from the first optical path synthesizing unit 52 shifts from a predetermined position (reference position), the transfer-optical-device control device 31 controls a position of the transfer optical device 30 so as to eliminate the shift. This will be described later in detail.

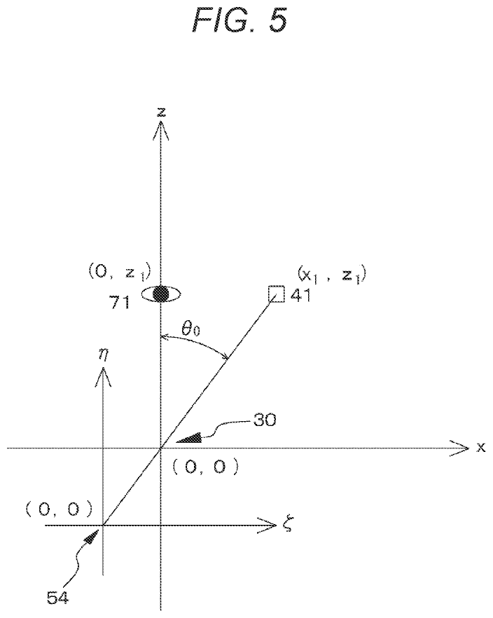

Further, in the display apparatus of the first embodiment, an emission angle of light (position detection center light) from the transfer optical device 30, the light having been emitted from the center of the light source 51, is different from an emission angle of light (image forming center light) from the transfer optical device 30, the light having been emitted from the center of the image forming device 20, by θ₀ (degrees) as illustrated in FIG. 5. A value of θ₀ only needs to be determined on the basis of specifications and the like required for the display apparatus. In practice, the emission angle is stereoscopically (three-dimensionally) different in an xyz space. In FIG. 1, the emission angle of the light (position detection center light) from the transfer optical device 30, the light having been emitted from the center of the light source 51, and the emission angle of the light (image forming center light) from the transfer optical device 30, the light having been emitted from the center of the image forming device 20, are illustrated as if those emission angles have the same angle. However, in practice, a first unit on which the image forming device 20, the second optical path synthesizing unit 53, the transfer optical device 30, and the second position detection device 60 are placed and a second unit on which the light source 51, the first optical path synthesizing unit 52, the second optical path synthesizing unit 53, and the light receiving unit 54 are placed are arranged such that, for example, the position detection center light from the light source 51 is incident on the first optical path synthesizing unit 52 at 45 degrees but is incident on the second optical path synthesizing unit 53 at an angle other than 45 degrees. Note that it is possible to make the emission angles different by the angle θ₀ (degrees) also by appropriately setting relative arrangement angles of the first optical path synthesizing unit 52 and the second optical path synthesizing unit 53. Note that, in this case, the position of the light receiving unit 54 only needs to be optimized as necessary. Further, the light (position detection center light) emitted from the center of the light source 51 and the light (image forming center light) emitted from the center of the image forming device 20 do not always intersect in the transfer optical device 30 as illustrated in FIG. 5, only need to be determined on the basis of the specifications and the like required for the display apparatus, and may intersect in, for example, the second optical path synthesizing unit 53.

Alternatively, it is desirable to determine the angle θ₀ in consideration of the following points. That is, when the transfer optical device is controlled such that the image forming center light passes through the center of the eyepiece optical device 40A, in an expected moving range of the observer,

[1] the position display means 41 always falls within a spot of the position detection light, and

[2] the position detection light including the return light is always incident on and emitted from the transfer optical device 30 and falls within an effective area of all optical components including the light receiving unit 54.

Note that, regarding the points [1] and [2], it is necessary to design the angle in consideration of not only a state in which the position display means is static but also a margin of a state in which the position display means is dynamic (an amount of movement during a time from when the position display means moves to when the next feedback is applied).

In a case where an image is observed with one eye, only one display apparatus needs to be used. Further, in a case where an image is observed with both eyes, two display apparatuses need to be used, or one display apparatus having the following configuration may be used. That is, the display apparatus may include two eyepiece optical devices 40A and an image display device including one image forming device and two transfer optical devices 30 that bifurcate an image incident from the one image forming device and emit the bifurcated images to the two eyepiece optical devices 40A. Alternatively, the display apparatus may include two eyepiece optical devices 40A and an image display device including one image forming device and one transfer optical device 30 that receives an image incident from the one image forming device, divides the image into two images, and emits the divided images to the two eyepiece optical devices 40A.

In the display apparatus of the first embodiment, the transfer-optical-device control device 31 controls the transfer optical device 30 such that the image incident from the image forming device 20 reaches the eyepiece optical device 40A under the control of the control unit 11 on the basis of the position information of the eyepiece optical device 40A detected by the first position detection device 50. Specifically, when the position of the eyepiece optical device 40A changes (specifically, for example, when the observer 70 moves) from a state in which the light (position detection light) from the first optical path synthesizing unit 52 is incident on the predetermined position (reference position) of the light receiving unit 54, a position where the light (position detection light) from the first optical path synthesizing unit 52 is incident on the light receiving unit 54 changes. A direction in the light receiving unit 54 corresponding to the x direction will be referred to as a “ζ direction”, and a direction in the light receiving unit 54 corresponding to the y direction will be referred to as an “η direction”. Then, a change in the position of the eyepiece optical device 40A in the x direction is a change in the position where the light (position detection light) from the first optical path synthesizing unit 52 is incident on the light receiving unit 54 in the ζ direction. Further, a change in the position of the eyepiece optical device 40A in the y direction is a change in the position where the light (position detection light) from the first optical path synthesizing unit 52 is incident on the light receiving unit 54 in the η direction.

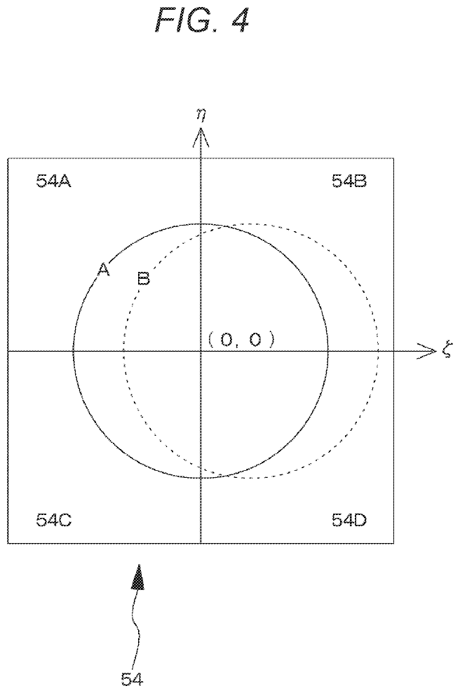

Therefore, as described above, the transfer-optical-device control device 31 controls the position of the transfer optical device 30 such that the light (position detection light) from the first optical path synthesizing unit 52 is incident on the predetermined position of the light receiving unit 54, thereby reliably causing the image forming light from the transfer optical device 30 to be incident on the pupil 71 of the observer 70. In a case where the incident position of the light incident on the light receiving unit 54 from the first optical path synthesizing unit 52 shifts from the predetermined position, this “shift” is detected as an error signal (a signal whose voltage changes according to an amount of the shift) in the light receiving unit 54. That is, when a voltage value of a signal in a state in which the light from the first optical path synthesizing unit 52 (the return light of the position detection light) is incident on the predetermined position (reference position) of the light receiving unit 54 is denoted by V₀ and a voltage value of a signal in a state in which the incident position of the light (return light) incident on the light receiving unit 54 from the first optical path synthesizing unit 52 shifts from the predetermined position (reference position) is denoted by V₁, the transfer-optical-device control device 31 controls the position of the transfer optical device 30 such that V₁ is V₀. Note that a position detection light spot to the light receiving unit 54 obtained when the voltage value is V₀ is indicated by a solid line “A” circle in FIG. 4, and a position detection light spot to the light receiving unit 54 obtained when the voltage value is V₁ is indicated by a dotted line “B” circle in FIG. 4. Further, conceptually, the transfer-optical-device control device 31 controls the position of the transfer optical device 30 such that the circle “B” overlaps the circle “A”.

As described above, the light receiving unit 54 has a structure in which the four photodiodes 54A, 54B, 54C, and 54D are arranged in a “cross-in-square” shape (a structure in which the photodiodes are arrayed in 2×2). Then, an output voltage (to be exact, the output is a current, but, generally, an I-V conversion element is arranged at a subsequent stage and the output is converted into a voltage for use, and thus description thereof is omitted) changes depending on an amount of light received by each of the photodiodes 54A, 54B, 54C, and 54D. Four voltage signals output from the respective photodiodes 54A, 54B, 54C, and 54D are converted into error signals through an operation circuit of an operational amplifier provided in the control unit 11. When output signals from the respective photodiodes 54A, 54B, 54C, and 54D are denoted by V_{A}, V_{B}, V_{C}, and V_{D}, error signals in the ζ direction (corresponding to the x direction) and the η direction (corresponding to the y direction) can be calculated as follows.

ζ_{Error}=(V_{A}+V_{C})−(V_{B}+V_{D})

η_{Error}=(V_{A}+V_{B})−(V_{C}+V_{D})

Note that the magnitude of the error signals changes when the amount of light changes, and thus a signal obtained by normalizing the error signal in each direction with a sum signal (=V_{A}+V_{B}+V_{C}+V_{D}) is used as an actual control signal in many cases, but description thereof is herein omitted.

A relationship between the error signals and the positions of the transfer optical device 30 and the eyepiece optical device 40A will be described with reference to FIG. 4. As described above, in a case where the transfer optical device 30 is controlled such that a value of ζ_{Error} is “0”, the image forming center light is emitted from the transfer optical device 30 such that the image forming center light is incident on, for example, the center of the eyepiece optical device 40A. That is, conceptually, it is possible to cause the image forming center light to be incident on, for example, the center of the eyepiece optical device 40A by controlling the transfer optical device 30 such that the center of gravity of the position detection light spot indicated by the dotted line “B” in FIG. 4 overlaps with the center of the circle indicated by the solid line “A”. On the contrary, in a case where the value of ζ_{Error} is set to a certain value V_{X_offset} other than “0”, it is possible to create a system (state) in which a state in which the position detection center light is incident on a position shifting from the center of the light receiving unit 54 is normal. That is, in a case where the position detection light spot is located at a position indicated by the dotted line “B” in FIG. 4, the image forming center light can be defined as being incident on the center of the eyepiece optical device 40A.

Hereinafter, in order to simplify description, description will be made on the assumption that the eyepiece optical device 40A, the image forming device 20, the transfer optical device 30, the first position detection device 50, the second position detection device 60, and the pupil 71 of the observer 70 are located in an xz plane and the image forming center light and the position detection center light travel in the xz plane, which is different from an actual case. Because y≡0 is satisfied, a value of a y coordinate in various (x, y, z) coordinates is omitted, and (x, z) coordinates are indicated. Further, coordinates of the position of the position detection center light in the light receiving unit 54 are indicated by (ζ, η). The coordinate corresponds to the x coordinate, and the η coordinate corresponds to the y coordinate. The light receiving unit 54 handles two-dimensional coordinates, and thus the coordinates of the position of the position detection center light are indicated by (ζ, η). Because y≡0 is satisfied, η≡0 is established.

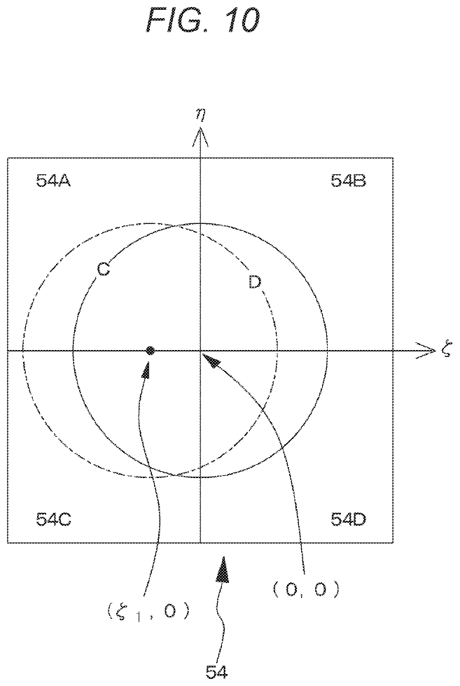

As illustrated in a conceptual diagram of FIG. 5, coordinates (x, z) of the transfer optical device 30 on which the image forming center light is incident are set to (0, 0). Further, coordinates of the position of the pupil 71 of the observer 70 are set to (0, z₁), and coordinates of the position display means 41 of the eyepiece optical device 40A are set to (x₁, z₁′). However, in order to simplify the following description, z₁=z₁′ is satisfied. At this time, the coordinates (ζ, η) of the position of the position detection center light in the light receiving unit 54 are set to (0, 0). A position of the position detection light spot in the light receiving unit 54 at this time is indicated by a solid line “C” in FIG. 10. This state is set as an initial state.

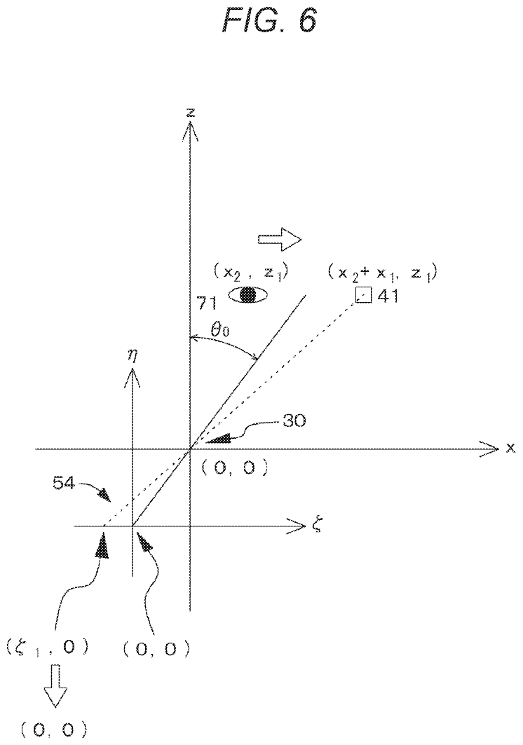

As illustrated in a conceptual diagram of FIG. 6, it is assumed that the observer 70 moves in parallel to the x direction from the initial state (see FIG. 5) (that is, moves while maintaining the z coordinate (=z₁)) and the coordinates of the position of the pupil 71 of the observer 70 become (x₂, z₁). Accordingly, the coordinates of the position display means 41 of the eyepiece optical device 40A become (x₂+x₁, z₁). At this time, the coordinates of the position of the position detection center light in the light receiving unit 54 change from (0, 0) to (ζ₁, 0). The position of the position detection light spot in the light receiving unit 54 at this time is indicated by a long dashed short dashed line “D” in FIG. 10. Then, the transfer-optical-device control device 31 controls the position of the transfer optical device 30 such that the coordinates of the position of the position detection center light in the light receiving unit 54 change from (ζ₁, 0) to (0, 0).

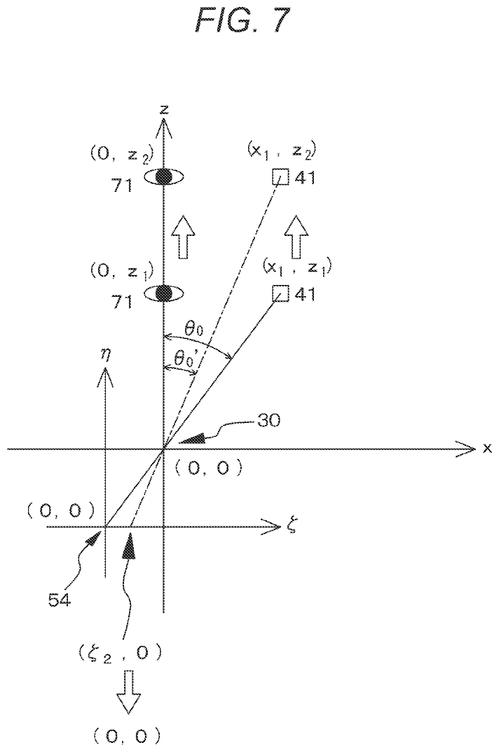

Next, as illustrated in FIG. 7, it is assumed that the pupil 71 of the observer 70 moves to z₂ in the z direction away from the transfer optical device 30 while maintaining the x coordinate (=0). The coordinates of the pupil 71 of the observer 70 are (0, z₂). At this time, the coordinates of the position display means 41 become (x₁, z₂). Further, the coordinates of the position of the position detection center light in the light receiving unit 54 at this time are set to (ζ₂, 0). As is clear also from FIG. 7, the pupil 71 of the observer 70 maintains the x coordinate (=0), and thus it is originally unnecessary to change the image forming center light emitted from the transfer optical device 30. However, the coordinates of the position of the position detection center light in the light receiving unit 54 change from (0, 0) to (ζ₂, 0). Therefore, in a case where the image forming center light emitted from the transfer optical device 30 is changed according to such the change in the position of the position detection center light in the light receiving unit 54 caused by the movement of the observer 70 in the z direction, the image forming light does not reach the pupil 71 of the observer 70. A value of ζ₂ can be expressed by a function of the position (distance) of the eyepiece optical device 40A. Note that k in Expression (C) below denotes a value depending on the position (coordinate) of the light receiving unit 54 in the z direction. Therefore, for example, by tabulating a relationship between values of k, x₁, and z₁, the value of ζ₂ can be obtained by obtaining a value of z₂ by using the second position detection device 60.

ζ₂=k(1/z₁−1/z₂)x₁ (C)

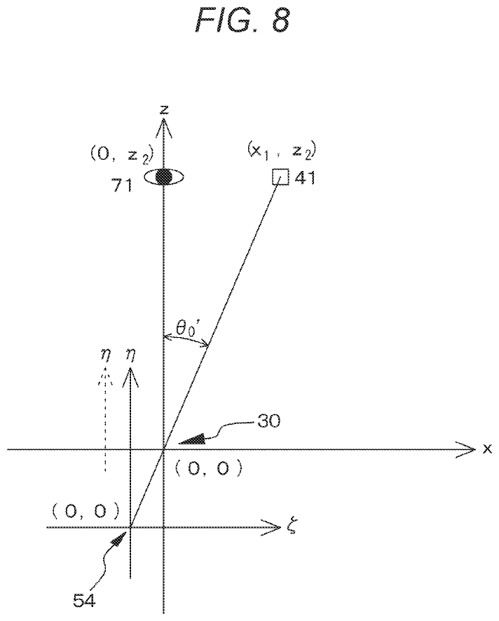

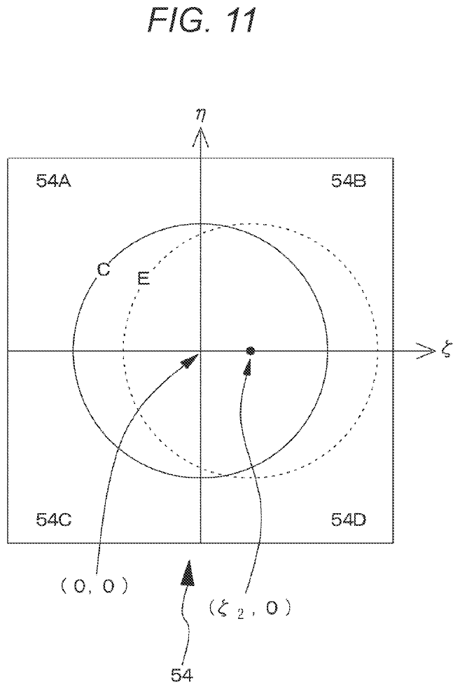

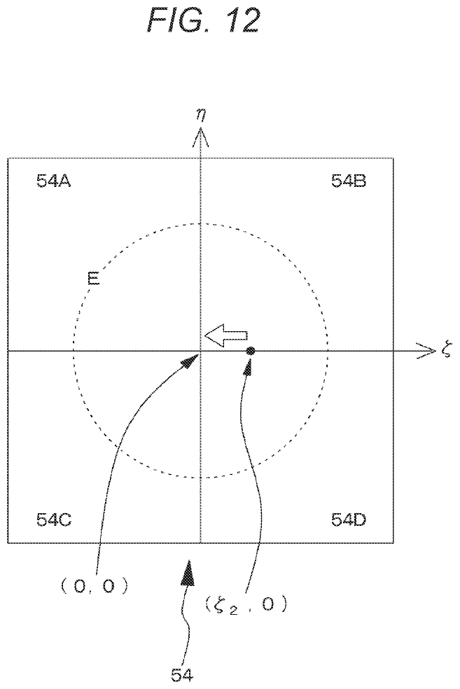

Here, a distance from the transfer optical device 30 to the position display means 41 of the eyepiece optical device 40A is obtained by the second position detection device 60, and thus the position (z₂) of the position display means 41 of the eyepiece optical device 40A with respect to the transfer optical device 30 is obtained. Therefore, the coordinates (ζ₂, 0) of the position of the position detection center light can be obtained according to Expression (C). The position of the position detection light spot in the light receiving unit 54 at this time is indicated by a dotted line “E” in FIG. 11. As described above, by adding a predetermined amount of offset to the error signal as if the coordinates (ζ₂, 0) of the position of the position detection center light in the light receiving unit 54 become coordinates (0, 0), it is possible to reset an origin [the predetermined position (reference position)] of the coordinates of the position display means 41 caused by the movement of the observer 70 in the z direction. The position of the position detection light spot in the light receiving unit 54 at this time is indicated by a dotted line “E” in FIG. 12. Further, FIG. 8 illustrates a conceptual diagram of the display apparatus. The emission angle of the light (image forming center light) from the transfer optical device 30, the light having been emitted from the center of the image forming device 20, is different by θ₀ (degrees) as illustrated in FIG. 7. As described above, the value of θ₀ is a value determined on the basis of the specifications and the like required for the display apparatus and is a fixed value. Here, an angle between a straight line (indicated by a dotted line in FIG. 7 and indicated by a solid line in FIG. 8) connecting the transfer optical device 30 and the position display means 41 when the position of the position display means 41 of the eyepiece optical device 40A becomes z₂ and a straight line (indicated by the z axis in FIGS. 7 and 8) connecting the transfer optical device 30 and the pupil 71 of the observer 70 is set to θ₀′. In this case, the transfer optical device 30 only needs to be controlled such that the position detection light is emitted from the transfer optical device 30 toward the position display means 41 at an angle obtained by subtracting the angle θ₀′ from the angle θ₀ ([θ₀−θ₀′], which is referred to as an “angle offset value” for convenience). Here, the angle offset value corresponds to the amount of offset added to the error signal as if the coordinates (ζ₂, 0) of the position of the position detection center light in the light receiving unit 54 become the coordinates (0, 0). Note that, in a case where an amount of movement in the x direction is large and the position of the position detection light spot in the light receiving unit 54 is almost out of a detection effective area of the light receiving unit 54, it is only necessary to add a predetermined amount of position correction offset to the error signal to change the origin [the predetermined position (reference position)] of the coordinates of the position display means 41.

As described above, the coordinates of the position of the position detection light spot in the light receiving unit 54 do not reflect the position of the eyepiece optical device 40A (observer 70) in the z direction. Such a problem is caused by a fact that the emission angle of the image forming light emitted from the transfer optical device 30 does not match with the emission angle of the position detection light. In the example of FIG. 5, the emission angle of the image forming light emitted from the transfer optical device 30 is 0 degrees, and the emission angle of the position detection light emitted from the transfer optical device 30 is θ₀ (degrees). In a case where an emission point of the image forming light from the transfer optical device 30 and an emission point of the position detection light from the transfer optical device 30 are separated from each other to match the emission angle of the image forming light emitted from the transfer optical device 30 with the emission angle of the position detection light, the above problem can be avoided. However, there arises a problem that the display apparatus increases in size because a distance between those emission points is too long. Alternatively, in a case where the position display means 41 is arranged on a light beam incident on the pupil 71 of the observer 70 or in a case where the center of gravity of the position display means 41 is located on the light beam, the above problem can be avoided. However, it is extremely difficult to adopt such a structure in practice.

Therefore, the control unit 11 corrects the position detected by the first position detection device 50 on the basis of the position information of the eyepiece optical device 40A detected by the second position detection device 60. Specifically, a relationship between an amount of change in the position (distance) from the eyepiece optical device 40A and an amount of change in the position of the position detection center light in the ζ direction and the η direction in the light receiving unit 54 is obtained in advance, and the position (distance) of the eyepiece optical device 40A is detected by the second position detection device 60. Then, on the basis of the detection result, the position detected by the first position detection device 50 is corrected (specifically, the detected position of the position detection light in the light receiving unit 54 is corrected). By constantly performing this correction in real time, it is possible to achieve a video experience without discomfort even in a case where the observer 70 moves forward and backward (in the z direction) with respect to the display apparatus.

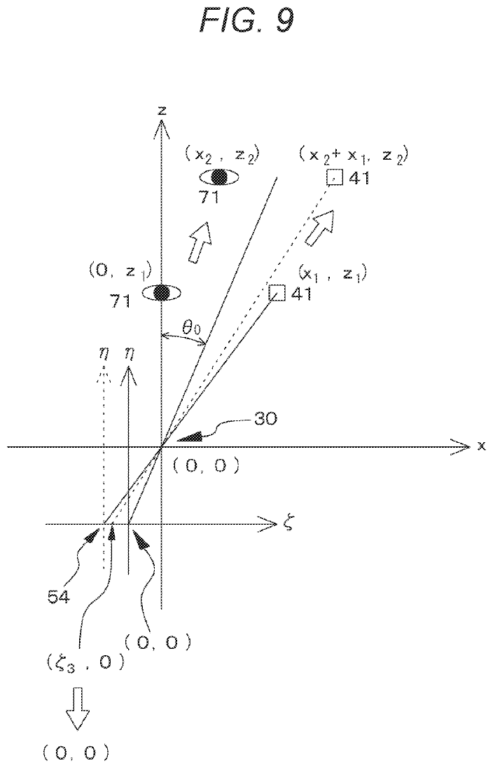

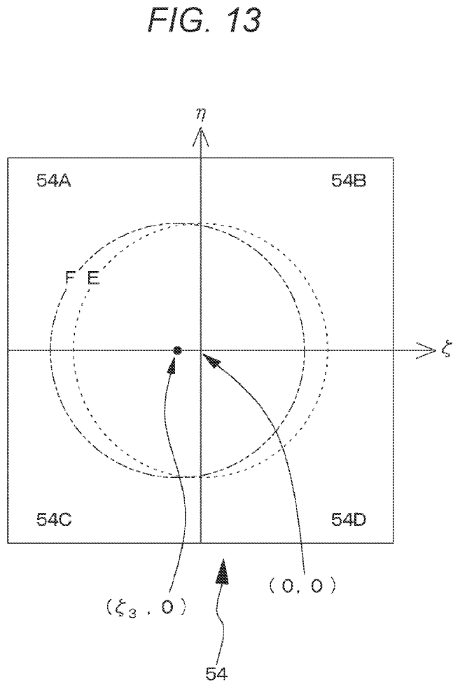

Next, as illustrated in a conceptual diagram of FIG. 9, it is assumed that the observer 70 moves from the initial state, and the coordinates of the position of the pupil 71 of the observer 70 change from (0, z₁) to (x₂, z₂). Accordingly, the coordinates of the position display means 41 of the eyepiece optical device 40A change from (x₁, z₁) to (x₂+x₁, z₂). Further, the coordinates of the position of the position detection center light in the light receiving unit 54 change from (0, 0) to (ζ₃, 0). That is, the distance from the transfer optical device 30 to the position display means 41 of the eyepiece optical device 40A obtained by the second position detection device 60 changes. The position of the position detection light spot in the light receiving unit 54 at this time is indicated by a long dashed double-short dashed line “F” in FIG. 13. In such a case, the control unit 11 only needs to first perform the processing described with reference to FIGS. 7, 8, 11, and 12, and then perform the processing described with reference to FIGS. 6 and 10.

By analyzing the change in the position of the position detection light spot in the light receiving unit 54 as described above, a direction of the position display means 41 of the eyepiece optical device 40A as viewed from the transfer optical device 30 is determined. Further, as described above, it is possible to obtain the position of the position display means 41 of the eyepiece optical device 40A with reference to the transfer optical device 30. That is, the above (x₂, z₂) can be obtained.

Then, the origin [the predetermined position (reference position)] of the coordinates of the position display means 41 caused by the movement of the observer 70 in the z direction is reset, and a circle indicated by the dotted line “E” in FIG. 12 becomes a reference. Thus, the transfer-optical-device control device 31 only needs to control the position of the transfer optical device 30 such that the center of gravity of a position detection light spot indicated by the long dashed double-short dashed line “F” in FIG. 13 overlaps with the center of a circle indicated by the dotted line “E”.

Hereinafter, control of the transfer optical device 30 will be described.

[Step-A]

First, position information (x, y, z) of the eyepiece optical device 40A is acquired. Specifically, position information (x, y) from the eyepiece optical device 40A is obtained by the first position detection device 50 (in the above-described example, an amount of change from (x₁, z₁) serving as a reference), and position information of the eyepiece optical device 40A (which is distance information and is a value of (x₂²+z₂²)^{1/2} in the above-described example) is obtained by the second position detection device 60.

[Step-B]

On the basis of those pieces of information, the control unit 11 performs various kinds of image processing including divergence/convergence processing of an image and expansion/contraction processing or shift processing of the image. Further, on the basis of those pieces of information, the control unit 11 determines the amount of offset to be added to the error signal (determines a value of (ζ₂, 0) in the above-described example). Thus, the incident position of the position detection light on the light receiving unit 54 can determine the predetermined position (reference position). Note that either of those processes may be performed first, or may be simultaneously performed.

[Step-C]

Then, the voltage signals are acquired from the light receiving unit 54, and the error signals (ζ_{Error}, η_{Error}) are calculated. On the basis of the error signals, whether or not the incident position of the position detection light on the light receiving unit 54 is the predetermined position (reference position) is confirmed, and, in a case where the incident position is the predetermined position (reference position), the transfer optical device 30 remains as it is, whereas, in a case where the incident position is not the predetermined position (reference position), the transfer optical device 30 is moved to the predetermined position (reference position).

Hereinabove, a case where the observer moves in a plane corresponding to the xz plane has been described. However, the same applies to a case where the observer moves in a plane corresponding to a yz plane and a case where the observer moves in a space corresponding to the xyz space.

Further, a design position of the eyepiece optical device 40A of the display apparatus and a design detected position of the position detection light in the light receiving unit 54 shift from each other in some cases. Such a shift occurs when, for example, the display apparatus is manufactured. Therefore, in order to eliminate such a shift, a shift compensation signal may be added to a signal from the light receiving unit 54.

Further, depending on the relative positional relationship between the transfer optical device 30 and the eyepiece optical device 40A, a shift occurs in a position where the image from the image forming device 20 is observed by the observer 70 (that is, the observer can observe the image, but a position thereof is shifted), or the image is distorted in some cases. In such cases, the control unit 11 only needs to control formation of the image in the image forming device 20 on the basis of the position information of the eyepiece optical device 40A detected by the first position detection device 50. Specifically, it is preferable to correct the position of the image formed in the image forming device 20 on the basis of the position information of the eyepiece optical device 40A. Further, depending on, for example, the distance from the transfer optical device 30 to the eyepiece optical device 40A detected by the second position detection device 60, the following problems may occur: a change in size of the image to be formed on the retina of the observer 70; defocusing of the image; divergence and convergence of the image; and distortion and aberration of the image. In such cases, the control unit 11 controls the formation of the image in the image forming device 20 on the basis of the position (distance) information from the transfer optical device 30 to the eyepiece optical device 40A detected by the second position detection device 60, thereby avoiding such problems. Further, it is also possible to finely adjust the position of the image to be formed on the retina of the observer 70 by controlling an emission position of the image from the image forming device to shift the image. Specifically, the image to be emitted from the image forming device can be shifted by making an image forming region in the image forming device larger than the image to be displayed and controlling a position where the image is formed in the image forming region, specifically, by moving the image in a direction corresponding to the x direction, by moving the image in a direction corresponding to the y direction, or by moving the image in directions corresponding to the x direction and the y direction.

In the first embodiment, in order to reduce a burden for the observer to wear the eyepiece optical device, the image forming device, the transfer optical device, the first position detection device, and the second position detection device are arranged in the image display device. That is, in the display apparatus of the first embodiment, the image display device and the eyepiece optical device are spatially separated from each other, and the transfer optical device is controlled. Therefore, a burden such as an increase in mass or size of the eyepiece optical device is not imposed on the observer, and it is possible to reliably cause an image to reach the pupil of the observer, without imposing a burden on the observer.

Next, position control of the transfer optical device 30 will be described.

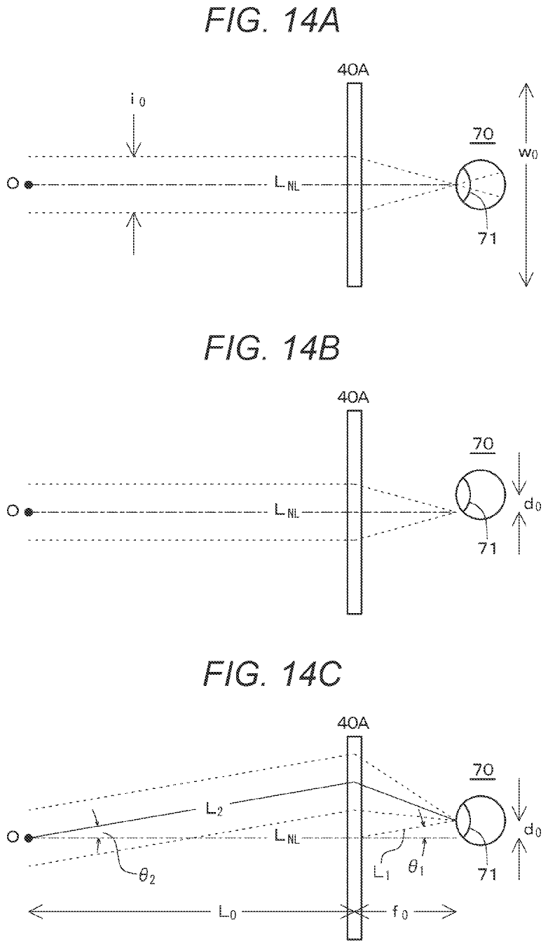

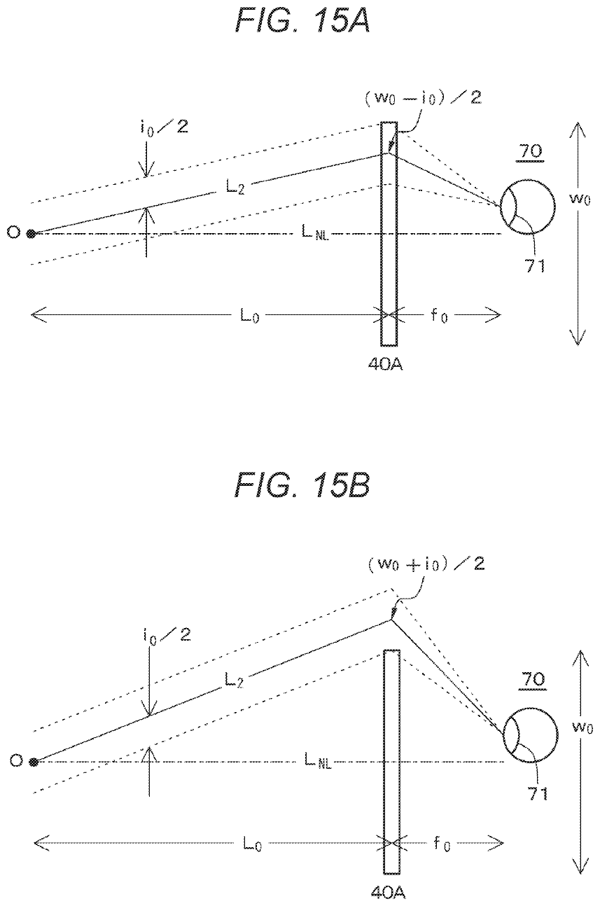

FIGS. 14A, 14B, 14C, 15A, and 15B schematically illustrate behavior of the luminous flux emitted from the transfer optical device 30 and a positional relationship between the eyepiece optical device 40A and the pupil 71 of the observer 70. FIG. 14A illustrates a case where the positional relationship between the eyepiece optical device 40A and the pupil 71 of the observer 70 is in a normal state. FIG. 14B illustrates a case where an amount of shift of the pupil 71 of the observer 70 from the eyepiece optical device 40A becomes d₀. FIG. 14C illustrates a state in which, in the state of FIG. 14B, an inclination of the transfer optical device 30 is controlled and an image emitted from the transfer optical device 30 is formed on the retina of the observer 70. In FIG. 14A and the like, “O” indicates the center of rotation of the transfer optical device 30, and a light beam emitted from the center of the image forming device 20 collides with the center of rotation “O” of the transfer optical device 30. Further, in FIGS. 14A, 14B, 14C, 15A, and 15B, the light beam emitted from the center of the image forming device 20 is indicated by a thin solid line, and light beams corresponding to edges of the image are indicated by thin broken lines.

First, there will be described an ideal state in which the eyepiece optical device 40A is sufficiently large with respect to a relative shift between a center position of the eyepiece optical device 40A and a center position of the pupil 71 of the observer 70. In this case, when an angle between a straight line L₁ connecting the center of the eyepiece optical device 40A and the center of the pupil 71 of the observer 70 and a normal line L_{NL} passing through the center of the eyepiece optical device 40A is denoted by θ₁ (projection angle θ₁), an angle between a light beam L₂ emitted from the center of the image forming device 20 to reach the eyepiece optical device 40A via the transfer optical device 30 and the normal line L_{NL} passing through the center of the eyepiece optical device 40A is denoted by θ₂, and a focal length of the eyepiece optical device 40A is denoted by f₀ (unit: mm),

the transfer-optical-device control device 31 only needs to control the transfer optical device 30 so as to satisfy

f₀·|tan(θ₂)−tan(θ₁)|≤3.5

preferably,

f₀·|tan(θ₂)−tan(θ₁)|≤1,

and more preferably θ₁=θ₂. Specifically, the inclination of the transfer optical device 30 only needs to be controlled. Note that, hereinafter, an example where the transfer-optical-device control device 31 controls the transfer optical device 30 so as to satisfy θ₁=θ₂ will be described for the sake of simplicity.

The angle θ₂ can be obtained from Expression (1) as illustrated in FIG. 14C.

θ₁=θ₂=tan⁻¹(d₀/f₀) (1)

Here,

d₀ denotes an amount of relative positional shift of the image (an amount of shift of the pupil of the observer with respect to the eyepiece optical device).

Meanwhile, in a case where an actual display apparatus is assumed, the size of the eyepiece optical device 40A is finite. Thus, when the transfer optical device 30 is controlled so as to satisfy Expression (1), the image emitted from the image forming device 20 may not reach the eyepiece optical device 40A and may therefore not reach the pupil 71 of the observer 70. Therefore, it is necessary to add a condition that Expression (1) is satisfied within a range in which the eyepiece optical device 40A spatially exists. Here, two premises are considered for a state in which the observer 70 cannot observe the image.

That is, a first premise is that part of the image should not be missing. A condition in a case where missing of the image observed by the observer 70 is not allowed is expressed by Expression (2) below as illustrated in FIG. 15A. Then, when Expression (2) is transformed, Expression (3) is obtained. FIG. 15A illustrates a state in which an outer edge of the image emitted from the transfer optical device 30 reaches an edge of the eyepiece optical device 40A and indicates that part of the image will be missing when the image emitted from the transfer optical device 30 moves further upward in FIG. 15A.

|L₀·tan(θ₂)|≤(w₀−i₀)/2 (2)

|L₀·(d₀/f₀)≤(w₀−i₀)/2 (3)

Here,

L₀ denotes a projection distance,

w₀ denotes the size of the eyepiece optical device, and

i₀ denotes a length (size) of one side of the projected image.

The transfer optical device 30 only needs to be controlled so as to satisfy Expression (1) (the above-described ideal condition) as long as Expression (3) is satisfied. Further, in a case where the expression is not satisfied, it is necessary to control the transfer optical device 30 such that the luminous flux is projected inside the edges of the eyepiece optical device 40A. Summarizing the above, Expressions (4-1) and (4-2) are established.

In a case of |L₀·(d₀/f₀)|≤(w₀−i₀)/2,

θ₂=tan⁻¹(d₀/f₀) (4-1)

In a case of |L₀·(d₀/f₀)|>(w₀−i₀)/2,

θ₂=tan⁻¹{(w₀−i₀)/2L₀) (4-2)

Further, a second premise is that a part of the image may be missing. A condition in a case where missing of the image observed by the observer 70 is allowed is expressed by Expression (5) below. Then, when Expression (5) is transformed, Expression (6) is obtained. Note that FIG. 15B illustrates a state in which an inner edge of the image emitted from the transfer optical device 30 reaches the edge of the eyepiece optical device 40A and indicates that the entire image will be missing when the image emitted from the transfer optical device 30 moves further upward in FIG. 15A.

|L₀·tan(θ₂)|≤(w₀+i₀)/2 (5)

|L₀·(d₀/f₀)|≤(w₀+i₀)/2 (6)

In a case where the expressions are not satisfied, it is only necessary to control the transfer optical device 30 such that even part of the luminous flux overlaps with the edge of the eyepiece optical device 40A. Summarizing the above, Expressions (7-1) and (7-2) are established. Note that θₗᵢₘᵢₜ denotes a possible maximum value of θ₂ (or the projection angle θ₁). Further, a possible range of θₗᵢₘᵢₜ is as follows.

tan⁻¹{(w₀−i₀)/2L₀)<θₗᵢₘᵢₜ<tan⁻¹{(w₀+i₀)/2L₀)

In a case of θ₁≤θₗᵢₘᵢₜ,

θ₂=tan⁻¹(d₀/f₀) (7-1)

In a case of θ₁>θₗᵢₘᵢₜ,

θ₂=θₗᵢₘᵢₜ (7-2)

The maximum value θₗᵢₘᵢₜ of θ₂ (or the projection angle θ₁) only needs to be determined depending on how much image missing is allowed. Further, the maximum value θₗᵢₘᵢₜ of θ₂ (or the projection angle θ₁) also changes depending on the content of the image. For example, in a case where an image has a black background, the length (size) i₀ of one side of the projected image is preferably set to be small.

The contents expressed by Expressions (4-1), (4-2), (7-1), and (7-2) indicate that it is necessary to project an image while setting a limit on θ₂ (or the projection angle θ₁). Therefore, when the position of the pupil 71 of the observer 70 shifts and a value of the amount of shift d₀ increases, the observer 70 eventually cannot observe the image. A condition in which the image cannot be observed needs to be set also in consideration of the size of the pupil of the observer 70 and thus changes also depending on an environment (brightness or the like). However, application of the present disclosure is equivalent to improvement in robustness regarding a positional relationship in which the observer 70 can observe an image and is extremely useful for more easily observing an image.

### Second Embodiment

The second embodiment is a modification of the first embodiment. In the first embodiment, the first position detection device 50 and the second position detection device 60 are separate components. Meanwhile, in the second embodiment, the first position detection device also serves as the second position detection device. That is, the light source 51 included in the first position detection device 50 is subjected to intensity modulation at a high frequency, the position detection light colliding with and reflected by the eyepiece optical device 40A is received by the light receiving unit 54, and the distance from the eyepiece optical device 40A is obtained on the basis of, for example, a phase delay time of a pulse wave. Specifically, the position detection light is modulated on the order of megahertz to gigahertz. Then, similarly to the first embodiment, the light (position detection light) emitted from the light source 51 reaches the eyepiece optical device 40A via the first optical path synthesizing unit 52, the second optical path synthesizing unit 53, and the transfer optical device 30, is returned to the transfer optical device 30 by the eyepiece optical device 40A, is incident on the first optical path synthesizing unit 52 via the transfer optical device 30 and the second optical path synthesizing unit 53, is emitted from the first optical path synthesizing unit 52 in a direction different from that of the light source 51, and is incident on the light receiving unit 54. Then, a signal output by the light receiving unit 54 is divided into components, i.e., a high frequency component corresponding to a modulation bandwidth (a bandwidth for detecting the distance from the eyepiece optical device) and a low frequency component of kilohertz or less (a bandwidth for detecting the position of the eyepiece optical device) and is subjected to signal processing. That is, the distance from the eyepiece optical device 40A is detected on the basis of the high frequency component output by the light receiving unit 54 by the TOF method or the indirect (indirect) TOF method. Further, the position of the eyepiece optical device 40A is detected on the basis of the low frequency component of kilohertz or less subjected to a low-pass filtering process.

As described above, the first position detection device also serves as the second position detection device. This makes it possible to obtain the position of the eyepiece optical device, without increasing the number of components or the number of retroreflective elements. In some cases, the distance from the eyepiece optical device may be obtained on the basis of the size (spot size) of the position detection light in the light receiving unit.

Except for the above point, the configuration and structure of the display apparatus in the second embodiment can be similar to the configuration and structure of the display apparatus in the first embodiment. Thus, detailed description thereof is omitted.

### Third Embodiment

The third embodiment is also a modification of the first embodiment. In the third embodiment, the second position detection device 60 includes a camera. Then, the distance from the position display means 41 is measured on the basis of the size of the position display means 41 or a distance between the plurality of position display means 41. The camera can also be used for coarse adjustment for specifying a position of an eyepiece optical device 40B (a position of the observer 70) at the start of the use of the display apparatus. That is, at the start of the use of the display apparatus, the position of the eyepiece optical device 40B (the observer 70) is searched for by the camera, and the transfer optical device 30 is coarsely adjusted. Then, when the light receiving unit 54 starts receiving the position detection light, the first position detection device 50 only needs to finely adjust the transfer optical device 30.

### Fourth Embodiment

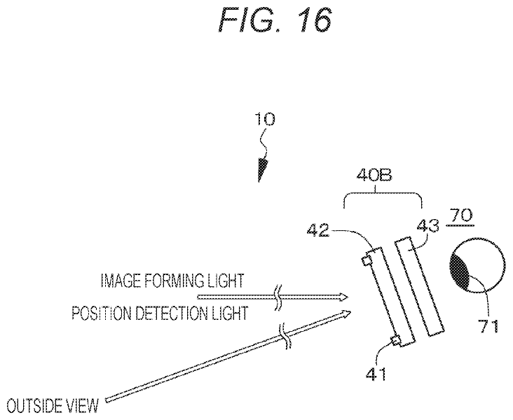

The fourth embodiment is a modification of the first to third embodiments. In a case where superimposition of an image and a background is required, it is desirable that the image display device 10 be not positioned in front of the observer 70. In a case where the image display device is always within a field of view of the observer, there is a possibility that the observer 70 cannot be immersed in the image or the outside view. As illustrated in a conceptual diagram of FIG. 16, in the display apparatus of the fourth embodiment, the image display device and the like (not illustrated) are arranged at a position other than the front of the observer 70. As a result, the observer 70 can observe the image and the outside view while the image display device and the like are outside the field of view of the observer. That is, the display apparatus can be a semi-transmission (see-through) device. This makes it possible to view the outside through the eyepiece optical device 40B. However, when the image display device (specifically, the transfer optical device) is arranged at a position other than the front of the observer 70, projected light is obliquely incident on the eyepiece optical device 40B. As a result, a focal point position of the eyepiece optical device 40B shifts from the pupil 71 of the observer 70, and thus the image may not reach the pupil 71 of the observer 70.

In order to solve such a problem, the eyepiece optical device 40B includes a diffractive optical member. The diffractive optical member includes diffraction means 42 having a diffraction function and light collection means 43 having a light collection function. The diffraction means 42 only needs to include, for example, a transmission volume hologram diffraction grating, and the light collection means 43 only needs to include, for example, a hologram element. Alternatively, the diffraction means 42 and the light collection means 43 may be provided as one member. Further, regarding the order of arrangement of the diffraction means 42 and the light collection means 43, the light collection means 43 may be arranged closer to the observer, or the diffraction means 42 may be arranged closer to the observer. Image forming light emitted from the transfer optical device (movable mirror) is deflected by the diffraction means 42, is changed in traveling angle (direction), is incident on the light collection means 43, and is collected by the light collection means 43, thereby forming an image on the retina of the observer 70. Wavelength selectivity of the light collection function is required to act only on a wavelength of the image forming light emitted from the image forming device. When the wavelength selectivity of the light collection function decreases and the eyepiece optical device 40B collects light having a wavelength other than the wavelength of the light emitted from the image forming device (e.g. light of the outside view), it is difficult for the observer 70 to observe the outside view.

In a case where a lens member made from general optical glass is used as the eyepiece optical device, the eyepiece optical device has no wavelength selectivity, and all visible light is collected and reaches the retina of the observer 70. Thus, the observer can observe only a projected image and cannot observe the outside view.

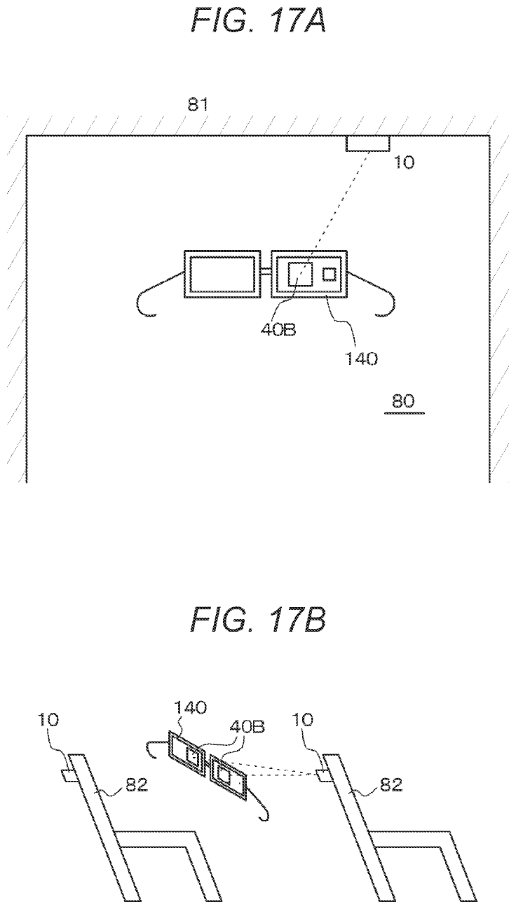

A usage example of the display apparatus in the fourth embodiment is illustrated in FIG. 17A. FIG. 17A is a schematic diagram of a state in which the display apparatus of the fourth embodiment is used in a room. The image display device 10 is disposed on a wall surface 81 of a room 80. When the observer 70 stands at a predetermined position in the room 80, an image from the image display device 10 reaches the eyepiece optical device 40B, and the observer 70 can observe the image via the eyepiece optical device 40B.

Alternatively, another usage example of the display apparatus in the fourth embodiment is illustrated in FIG. 17B. FIG. 17B is a schematic diagram of a state in which the image display device 10 included in the display apparatus of the fourth embodiment is disposed on a back surface of a back (backrest) of a seat 82. When the observer sits on a back seat 82, an image is emitted from the image display device 10 disposed on a back surface of a back of a front seat 82 toward the eyepiece optical device 40B worn by the observer and reaches the eyepiece optical device 40B, and the observer 70 can observe the image via the eyepiece optical device 40B. More specifically, for example, the image forming device for passengers can be attached to a back surface of a back (backrest) of a seat of a vehicle or an airplane, or the image forming device for spectators can be attached to a back surface of a back (backrest) of a seat of a theater or the like. Note that the usage examples of the display apparatus described above can also be applied to other embodiments.

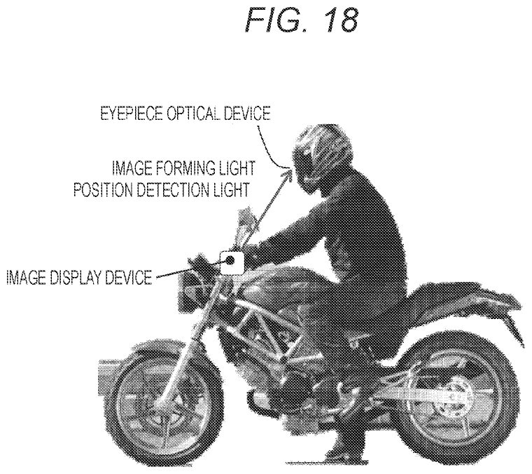

As illustrated in FIG. 18, the image display device may be attached to handlebars of a motorcycle, and the eyepiece optical device 40B may be attached to a full-face helmet worn by a driver of the motorcycle. Note that, in FIG. 18, the image forming light and the position detection light are indicated by an arrow. It is known that handlebars of motorcycles vibrate at high frequencies, in some cases, at 100 Hertz or more. Therefore, in a case where the first position detection device includes an imaging device of several tens of FPS to several hundreds of FPS, detection of position information of the eyepiece optical device cannot be followed by the first position detection device due to vibration transmitted to the image display device, and fine shakes cannot be completely removed from the image. This causes visually induced motion sickness. By adopting, for example, a TOF or indirect TOF distance measurement device as the second position detection device 60 and using, for example, the first position detection device 50 including the light receiving unit 54 including the plurality of photodiodes 54A, 54B, 54C, and 54D, it is possible to cope with the movement of the image display device on the order of 10 kilohertz to 100 kilohertz. This is further effective in incorporation into a moving body such as a motorcycle. Further application examples of the display apparatus in the fourth embodiment include an example where the image display device is incorporated into an automobile and the eyepiece optical device is incorporated into a windshield for the automobile and an example where the eyepiece optical device is incorporated into a protective face mask or the like.

### Fifth Embodiment

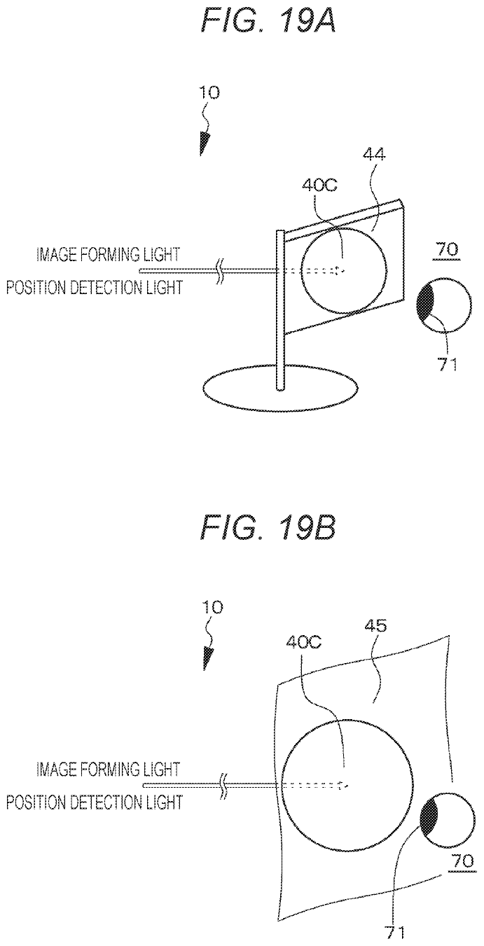

The fifth embodiment is a modification of the fourth embodiment. As illustrated in a conceptual diagram of FIG. 19A, in the display apparatus of the fifth embodiment, an eyepiece optical device 40C and the image display device 10 are relatively movable (that is, the image display device 10 is arranged at a position away from the observer 70), and, in addition, the eyepiece optical device 40C is also arranged at a position away from the observer 70. That is, the eyepiece optical device 40C is not worn by the observer 70. The eyepiece optical device 40C is a stationary device and is held by a holding member 44 or is incorporated into the holding member 44 integrally with the holding member 44. The holding member 44 and the eyepiece optical device 40C are folded and stored when being carried, and the eyepiece optical device 40C is assembled when the display apparatus is used. Positions of the transfer optical device 30 and the eyepiece optical device 40C only need to be adjusted at the time of assembly, and, in principle, a positional relationship therebetween does not change during use. An image emitted from the image forming device 20 reaches the pupil 71 of the observer 70 via the eyepiece optical device 40C. Such the display apparatus of the fifth embodiment is, for example, a retinal projection mini monitor. The eyepiece optical device 40C has a similar configuration and structure to those of the eyepiece optical device 40B described in the fourth embodiment.

Alternatively, as illustrated in a conceptual diagram of FIG. 19B, the stationary eyepiece optical device 40C is incorporated into a glass window 45 or exhibit window of a museum, art museum, observation deck, aquarium, or the like. Also in this case, the positions of the transfer optical device 30 and the eyepiece optical device 40C do not change, and an image emitted from the image forming device 20 reaches the pupil 71 of the observer 70 via the eyepiece optical device 40C. Note that, in FIGS. 19A and 19B, as well as in FIG. 16, illustration of the image display device and the like is omitted.

### Sixth Embodiment

The sixth embodiment is a modification of the first to fifth embodiments.

Expressions (4-1), (4-2), (7-1), and (7-2) described above show a position of projected light in the eyepiece optical device. Here, when the value of the amount of relative positional shift d₀ of an image (the amount of shift of the pupil of the observer with respect to the eyepiece optical device) is constant, the value of θ₂ (or the projection angle θ₁) can be decreased as the focal length f₀ of an eyepiece optical device 40D is increased. In other words, it is possible to cope with the larger amount of shift d₀ as the focal length f₀ of the eyepiece optical device 40D is increased. Therefore, it is possible to increase a value of the controllable amount of shift d₀, without losing the ideal condition.

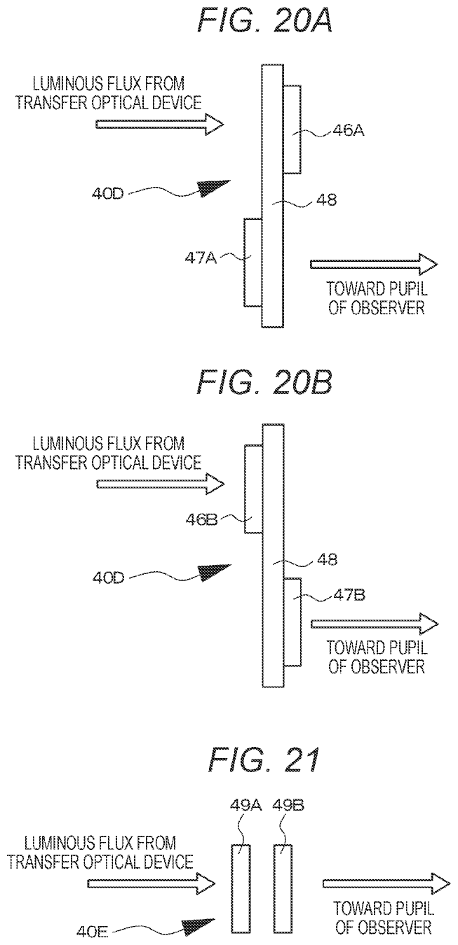

As illustrated in conceptual diagrams of the eyepiece optical device 40D in FIGS. 20A and 20B, in the display apparatus of the sixth embodiment, the eyepiece optical device 40D includes a light collection member 46A or 46B on which an image from the transfer optical device 30 is incident and a deflection member 47A or 47B that guides light emitted from the light collection member 46A or 46B to the pupil 71 of the observer 70. A propagation direction of the image from the transfer optical device 30 can be changed in a direction toward the deflection member 47A or 47B by the light collection member 46A or 46B. The light collection members 46A and 46B and the deflection members 47A and 47B are attached to, but not limited to, a support member 48 or are provided in the support member 48 integrally with the support member 48. The light collection member 46A or 46B and the deflection member 47A or 47B are combined as described above to fold back an optical path, thereby extending the focal length f₀. Note that, as illustrated in FIG. 20A, the light collection member 46A includes a reflective hologram element, and the deflection member 47A includes a reflective volume hologram diffraction grating. Alternatively, as illustrated in FIG. 20B, the light collection member 46B includes a transmission hologram lens, and the deflection member 47B includes a transmission volume hologram diffraction grating. However, the light collection members and the deflection members are not limited thereto. Further, light from the light collection member may be totally reflected once or more than once in the support member and then be incident on the deflection member.

### Seventh Embodiment

The seventh embodiment is a modification of the first to sixth embodiments. As illustrated in a conceptual diagram of

FIG. 21, in the display apparatus of the seventh embodiment, an eyepiece optical device 40E includes a diffraction grating 49B and further includes a light collection member 49A on the light incident side. Note that the light collection member 49A may be provided between the diffraction grating 49B and the pupil 71 of the observer 70. This makes it possible to obtain a structure equivalent to that having a plurality of focal points of the eyepiece optical device 40E. That is, even if, for example, an image emitted from the transfer optical device 30 described in the first embodiment does not reach the pupil 71 of the observer 70 for various reasons, for example, a 1st order diffracted light, a −1st order diffracted light, or the like of the diffraction grating 49B reaches the pupil 71 of the observer 70, instead of a 0th order diffracted light thereof. Therefore, it is possible to achieve a system having higher robustness for the observer 70. That is, it is possible to achieve a display apparatus having higher robustness while reducing a burden on the observer 70. Further, because a plurality of focal points can be prepared, it is possible to increase a range in which the observer 70 can observe the image even in a case where the value of θ₂ (or the projection angle θ₁) is large.

The image can be divided by the diffraction grating 49B into three images in the horizontal direction, into three images in the vertical direction, into three images in the horizontal direction and three images in the vertical direction in the shape of a cross (into five images in total because images having a center light path overlap with each other), into two images in the horizontal direction and two images in the vertical direction, i.e., 2×2=4, and into three images in the horizontal direction and three images in the vertical direction, i.e., 3×3=9.

### Eighth Embodiment

The eighth embodiment is a modification of the first to seventh embodiments. In the display apparatus of the eighth embodiment, a position of an image formed in the image forming device 20 is corrected on the basis of position information of an eyepiece optical device 40F detected by the first position detection device 50 and position information of the pupil 71 of the observer 70 detected by the second position detection device 60.

In the eighth embodiment, the image is formed in a region smaller than the entire image forming region in the image forming device. For example, when the entire image forming region is 1×1, a region where the image is formed is (p×q). Here, 0<p<1 and 0<q<1 are satisfied.

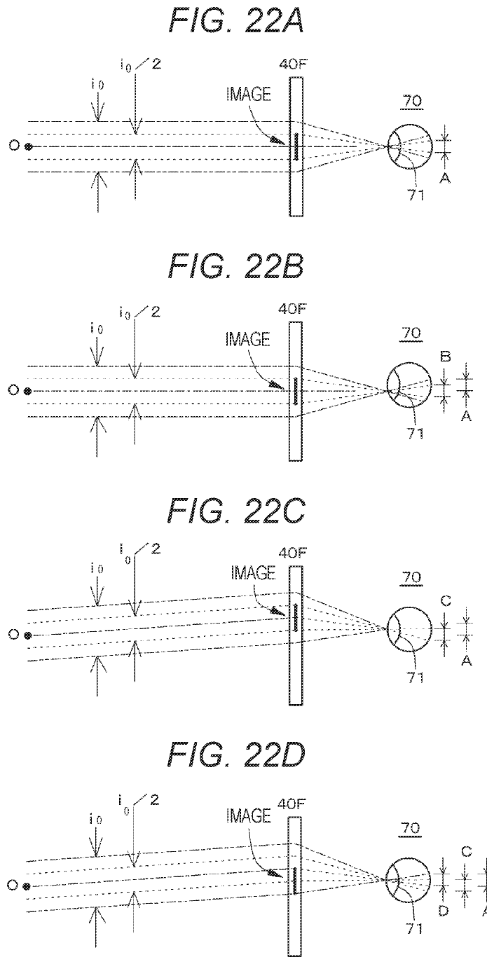

As illustrated in conceptual diagrams of FIGS. 22A, 22B, 22C, and 22D, edges of the image in a case where the image is formed on the basis of the entire image forming region (1×1) are indicated by long dashed double-short dashed lines, light from the center of the image in a case where the image is formed on the basis of the region (1×1) is indicated by a long dashed short dashed line, and edges of the image in a case where the image is formed on the basis of the region (p×q) where the image is formed are indicated by broken lines. In examples of FIGS. 22A, 22B, 22C, and 22D, p=q=0.5 is satisfied, and, when a length (size) of one side of the image formed on the basis of the entire image forming region (1×1) is denoted by i₀, a length (size) of one side of the image formed on the basis of the region (p×q) is i₀/2.

As illustrated in FIG. 22B, the pupil 71 of the observer 70 moves upward in the drawing from a state of FIG. 22A. An image observed by the observer 70 in the state of FIG. 22A is schematically indicated by arrows “A”, and an image observed by the observer 70 in a state of FIG. 22B is schematically indicated by arrows “B”. The image observed by the observer 70 moves to a lower side of the retina from the state indicated by the arrows “A” to the state indicated by the arrows “B”. As described above, the image on the retina observed by the observer 70 moves due to a change in relative positions of the eyepiece optical device 40F and the pupil 71 of the observer 70 as illustrated in FIGS. 22A and 22B. Then, in such a case, as illustrated in FIG. 22C and as described in the first to seventh embodiments, the transfer-optical-device control device controls the transfer optical device such that an image incident from the image forming device reaches the eyepiece optical device, that is, the image incident from the image forming device is formed on the retina of the observer 70 via the eyepiece optical device on the basis of the position information of the eyepiece optical device detected by the first position detection device and the position information of the pupil 71 of the observer 70 detected by the second position detection device. An image observed by the observer 70 in a state of FIG. 22C is schematically indicated by arrows “C”. The image observed by the observer 70 moves from the state indicated by the arrows “A” to the state indicated by the arrows “C” and remains on the lower side of the retina.

Therefore, the position of the image formed in the image forming device 20 is corrected on the basis of the position information of the eyepiece optical device 40F detected by the first position detection device 50 and the position information of the pupil 71 of the observer 70 detected by the second position detection device 60. Specifically, as illustrated in FIG. 22D, the region (p×q) is moved to an appropriate position in the image forming device 20 and an image is formed such that, when the observer 70 observes the image formed on the basis of the region (p×q), the image on the retina does not move or movement of the image on the retina is reduced as much as possible. For example, in a case where the image is formed in a central region of the image forming device 20 (see FIGS. 22A, 22B, and 22C), as illustrated in FIG. 22D, an image forming position in the image forming device 20 is corrected such that the image is formed in an upper region of the image forming device 20 (the image to be emitted from the transfer optical device is emitted from a lower portion of the transfer optical device). An image observed by the observer 70 in a state of FIG. 22D is schematically indicated by arrows “D”. That is, the image forming position in the image forming device 20 is shifted in a direction to eliminate a relative positional shift between the eyepiece optical device 40F and the pupil 71 of the observer 70. This makes it possible to more securely reduce movement of the image on the retina observed by the observer 70 as much as possible and to fix a display position of the image with respect to the field of view of the observer as much as possible.

The display apparatus of the present disclosure has been described above on the basis of the preferable embodiments. However, the display apparatus of the present disclosure is not limited to those embodiments. The configuration and structure of the display apparatus, and the configurations and structures of the image display device, the image forming device, the transfer optical device, and the eyepiece optical device can be appropriately changed. For example, in a case where the observer is located at an inappropriate place as viewed from the display apparatus, the display apparatus may guide the observer to an appropriate place by voice or image/video. The display apparatus may include a plurality of image forming devices. That is, the display apparatus may include a plurality of image forming devices that emits an image from different positions and can be configured such that the plurality of image forming devices emits the same image and one eyepiece optical device receives one of a plurality of images thereof. This makes it possible to increase the degree of freedom of the relative positional relationship between the image forming device and the observer. That is, for example, when the observer is at a predetermined position, an image from the image forming device reaches the eyepiece optical device, and the observer can observe the image via the eyepiece optical device, and the predetermined position can be enlarged.

Note that the present disclosure can also have the following configurations.

### [A01] <<Display Apparatus . . . First Aspect>>

A display apparatus including:

an eyepiece optical device; and

an image display device including an image forming device and a transfer optical device that emits an image incident from the image forming device to the eyepiece optical device, in which

the eyepiece optical device and the image display device are spatially separated from each other,

the eyepiece optical device forms the image from the transfer optical device on a retina of an observer,

the image display device further includes

a control unit,

a first position detection device and a second position detection device that detect a position of the eyepiece optical device, and

a transfer-optical-device control device, and

the transfer-optical-device control device controls the transfer optical device such that the image incident from the image forming device reaches the eyepiece optical device under the control of the control unit on the basis of position information of the eyepiece optical device detected by the first position detection device, and the control unit corrects the position detected by the first position detection device on the basis of position information of the eyepiece optical device detected by the second position detection device.

[A02] The display apparatus according to [A01], in which the control unit controls formation of the image in the image forming device on the basis of the position information of the eyepiece optical device detected by the first position detection device, by the second position detection device, or by the first position detection device and the second position detection device.
[A03] The display apparatus according to [A01] or [A02], in which

the first position detection device includes

a light source,

a first optical path synthesizing unit,

a second optical path synthesizing unit, and

a light receiving unit,

the image incident from the image forming device is formed on the retina of the observer via the second optical path synthesizing unit, the transfer optical device, and the eyepiece optical device, and

light emitted from the light source reaches the eyepiece optical device via the first optical path synthesizing unit, the second optical path synthesizing unit, and the transfer optical device, is returned to the transfer optical device by the eyepiece optical device, is incident on the first optical path synthesizing unit via the transfer optical device and the second optical path synthesizing unit, is emitted from the first optical path synthesizing unit in a direction different from a direction of the light source, and is incident on the light receiving unit.

[A04] The optical device according to [A03], in which in a case where an incident position of the light incident on the light receiving unit from the first optical path synthesizing unit shifts from a predetermined position, the transfer-optical-device control device controls a position of the transfer optical device so as to eliminate the shift.
[A05] The display apparatus according to [A03] or [A04], in which an emission angle of light from the transfer optical device, the light having been emitted from a center of the light source, is different from an emission angle of light from the transfer optical device, the light having been emitted from a center of the image forming device.
[A06] The display apparatus according to any one of [A03] to [A05], in which the light source emits an infrared ray in an eye-safe wavelength band.
[A07] The display apparatus according to any one of [A03] to [A06], in which the light emitted from the light source and incident on the first optical path synthesizing unit is divergent light.
[A08] The display apparatus according to any one of [A03] to [A07], in which the light receiving unit is arranged at a position closer to the first optical path synthesizing unit than to a position optically conjugate with the light source.
[A09] The display apparatus according to any one of [A03] to [A08], in which the light receiving unit includes a position sensitive detector, a multi-segmented photodiode, or a plurality of photodiodes.
[A10] The display apparatus according to any one of [A01] to [A09], in which the first position detection device also serves as the second position detection device.
[A11] The display apparatus according to any one of [A01] to [A10], in which the transfer-optical-device control device causes the transfer optical device to perform image projection control on the retina of the observer in a horizontal direction and a vertical direction of the image to be formed on the retina of the observer.
[A12] The optical device according to any one of [A01] to [A11], in which the transfer optical device includes a combination of two galvanometer mirrors.
[A13] The optical device according to any one of [A01] to

[A12], in which a retroreflective element is attached to the eyepiece optical device.

[A14] The display apparatus according to any one of [A01] to [A13], in which the eyepiece optical device includes a hologram element.
[A15] The display apparatus according to any one of [A01] to [A13], in which the eyepiece optical device includes a diffractive optical member.
[A16] The display apparatus according to any one of [A01] to [A13], in which the eyepiece optical device includes a light collection member and a deflection member.
[A17] The display apparatus according to any one of [A01] to [A16], in which the eyepiece optical device and the image display device are relatively movable.
[A18] The display apparatus according to any one of [A01] to

[A17], in which the eyepiece optical device is worn by the observer.

[A19] The display apparatus according to any one of [A01] to [A17], in which the eyepiece optical device is arranged at a position away from the observer.
[A20] The display apparatus according to any one of [A01] to [A19], in which

when an angle between a straight line connecting a center of the eyepiece optical device and a center of the pupil of the observer and a normal line passing through the center of the eyepiece optical device is denoted by θ₁, an angle between a light beam emitted from the center of the image forming device to reach the eyepiece optical device via the transfer optical device and the normal line passing through the center of the eyepiece optical device is denoted by θ₂, and a focal length of the eyepiece optical device is denoted by f₀ (unit: mm), the transfer-optical-device control device controls the transfer optical device so as to satisfy

f₀·|tan(θ₂)−tan(θ₁)|0≤3.5.

### [B01] <<Display Apparatus . . . Second Aspect>>

A display apparatus including:

an eyepiece optical device; and

an image display device including an image forming device and a transfer optical device that emits an image incident from the image forming device to the eyepiece optical device, in which

the eyepiece optical device and the image display device are spatially separated from each other,

the eyepiece optical device forms the image from the transfer optical device on a retina of an observer,

the image display device further includes

a control unit,

a first position detection device and a second position detection device that detect a position of the eyepiece optical device, and

a transfer-optical-device control device, and

the transfer-optical-device control device controls the transfer optical device such that the image incident from the image forming device reaches the eyepiece optical device under the control of the control unit on the basis of position information of the eyepiece optical device detected by the first position detection device, and the control unit controls formation of the image in the image forming device on the basis of the position information of the eyepiece optical device detected by the first position detection device, by the second position detection device, or by the first position detection device and the second position detection device.

[B02] The display apparatus according to [B01], in which the first position detection device also serves as the second position detection device.
[B03] The display apparatus according to [B01] or [B02], in which

the first position detection device includes

a light source,

a first optical path synthesizing unit,

a second optical path synthesizing unit, and

a light receiving unit,

the image incident from the image forming device is formed on the retina of the observer via the second optical path synthesizing unit, the transfer optical device, and the eyepiece optical device, and

light emitted from the light source reaches the eyepiece optical device via the first optical path synthesizing unit, the second optical path synthesizing unit, and the transfer optical device, is returned to the transfer optical device by the eyepiece optical device, is incident on the first optical path synthesizing unit via the transfer optical device and the second optical path synthesizing unit, is emitted from the first optical path synthesizing unit in a direction different from a direction of the light source, and is incident on the light receiving unit.

[B04] The optical device according to [B03], in which in a case where an incident position of the light incident on the light receiving unit from the first optical path synthesizing unit shifts from a predetermined position, the transfer-optical-device control device controls a position of the transfer optical device so as to eliminate the shift.
[B05] The display apparatus according to [B03] or [B04], in which an emission angle of light from the transfer optical device, the light having been emitted from a center of the light source, is different from an emission angle of light from the transfer optical device, the light having been emitted from a center of the image forming device.
[B06] The display apparatus according to any one of [B03] to [B05], in which the light source emits an infrared ray in an eye-safe wavelength band.
[B07] The display apparatus according to any one of [B03] to [B06], in which the light emitted from the light source and incident on the first optical path synthesizing unit is divergent light.
[B08] The display apparatus according to any one of [B03] to [B07], in which the light receiving unit is arranged at a position closer to the first optical path synthesizing unit than to a position optically conjugate with the light source.
[B09] The display apparatus according to any one of [B03] to [B08], in which the light receiving unit includes a position sensitive detector, a multi-segmented photodiode, or a plurality of photodiodes.
[B10] The display apparatus according to any one of [B01] to [B09], in which the transfer-optical-device control device causes the transfer optical device to perform image projection control on the retina of the observer in a horizontal direction and a vertical direction of the image to be formed on the retina of the observer.
[B11] The optical device according to any one of [B01] to [B10], in which the transfer optical device includes a combination of two galvanometer mirrors.
[B12] The optical device according to any one of [B01] to [B11], in which a retroreflective element is attached to the eyepiece optical device.
[B13] The display apparatus according to any one of [B01] to [B12], in which the eyepiece optical device includes a hologram element.
[B14] The display apparatus according to any one of [B01] to [B12], in which the eyepiece optical device includes a diffractive optical member.
[B15] The display apparatus according to any one of [B01] to [B12], in which the eyepiece optical device includes a light collection member and a deflection member.
[B16] The display apparatus according to any one of [B01] to [B15], in which the eyepiece optical device and the image display device are relatively movable.
[B17] The display apparatus according to any one of [B01] to [B16], in which the eyepiece optical device is worn by the observer.
[B18] The display apparatus according to any one of [B01] to [B16], in which the eyepiece optical device is arranged at a position away from the observer.
[B19] The display apparatus according to any one of [B01] to [B18], in which

when an angle between a straight line connecting a center of the eyepiece optical device and a center of the pupil of the observer and a normal line passing through the center of the eyepiece optical device is denoted by θ₁, an angle between a light beam emitted from the center of the image forming device to reach the eyepiece optical device via the transfer optical device and the normal line passing through the center of the eyepiece optical device is denoted by θ₂, and a focal length of the eyepiece optical device is denoted by f₀(unit: mm), the transfer-optical-device control device controls the transfer optical device so as to satisfy

f₀·|tan(θ₂)−tan(θ₁)|≤3.5.

[C01] <<Display Apparatus . . . Third Aspect>>

A display apparatus including:

an eyepiece optical device; and

an image display device including an image forming device and a transfer optical device that emits an image incident from the image forming device to the eyepiece optical device, in which

the eyepiece optical device and the image display device are spatially separated from each other,

the eyepiece optical device forms the image from the transfer optical device on a retina of an observer,

the image display device further includes a first position detection device that detects a position of the eyepiece optical device,

the first position detection device includes

a light source,

a first optical path synthesizing unit,

a second optical path synthesizing unit, and

a light receiving unit,

the image incident from the image forming device is formed on the retina of the observer via the second optical path synthesizing unit, the transfer optical device, and the eyepiece optical device, and

light emitted from the light source reaches the eyepiece optical device via the first optical path synthesizing unit, the second optical path synthesizing unit, and the transfer optical device, is returned to the transfer optical device by the eyepiece optical device, is incident on the first optical path synthesizing unit via the transfer optical device and the second optical path synthesizing unit, is emitted from the first optical path synthesizing unit in a direction different from a direction of the light source, and is incident on the light receiving unit.

[C02] The display apparatus according to [C01], in which an emission angle of light from the transfer optical device, the light having been emitted from a center of the light source, is different from an emission angle of light from the transfer optical device, the light having been emitted from a center of the image forming device.
[C03] The display apparatus according to [C01] or [C02], in which the light source emits an infrared ray in an eye-safe wavelength band.
[C04] The display apparatus according to any one of [C01] to [C03], in which the light emitted from the light source and incident on the first optical path synthesizing unit is divergent light.
[C05] The display apparatus according to any one of [C01] to [C04], in which the light receiving unit is arranged at a position closer to the first optical path synthesizing unit than to a position optically conjugate with the light source.
[C06] The display apparatus according to any one of [C01] to [C05], in which the light receiving unit includes a position sensitive detector, a multi-segmented photodiode, or a plurality of photodiodes.
[C07] The optical device according to any one of [C01] to [C06], in which the transfer optical device includes a combination of two galvanometer mirrors.
[C08] The optical device according to any one of [C01] to [C07], in which a retroreflective element is attached to the eyepiece optical device.
[C09] The display apparatus according to any one of [C01] to [C08], in which the eyepiece optical device includes a hologram element.
[C10] The display apparatus according to any one of [C01] to [C11], in which the eyepiece optical device includes a diffractive optical member.
[C11] The display apparatus according to any one of [C01] to [C10], in which the eyepiece optical device includes a light collection member and a deflection member.
[C12] The display apparatus according to any one of [C01] to [C11], in which the eyepiece optical device and the image display device are relatively movable.
[C13] The display apparatus according to any one of [C01] to [C12], in which the eyepiece optical device is worn by the observer.
[C14] The display apparatus according to any one of [C01] to [C12], in which the eyepiece optical device is arranged at a position away from the observer.
[C15] The display apparatus according to any one of [C01] to [C14], in which

when an angle between a straight line connecting a center of the eyepiece optical device and a center of the pupil of the observer and a normal line passing through the center of the eyepiece optical device is denoted by θ₁, an angle between a light beam emitted from the center of the image forming device to reach the eyepiece optical device via the transfer optical device and the normal line passing through the center of the eyepiece optical device is denoted by θ₂, and a focal length of the eyepiece optical device is denoted by f₀ (unit: mm), the transfer-optical-device control device controls the transfer optical device so as to satisfy

f₀·|tan(θ₂)−tan(θ₁)|≤3.5.

### REFERENCE SIGNS LIST

10 Image display device
11 Control unit
20, 20a, 20b, 20c Image forming device
21a Light source
21b Polarizing beam splitter
21c Liquid crystal display device (LCD)
21d Optical system
22a Organic EL display device
22b Convex lens
23a Light source
23b Collimating optical system
23c Total reflection mirror
23d Scanning means
23e Relay optical system

### 24 Housing

30 Transfer optical device
31 Transfer-optical-device control device
40A, 40B, 40C, 40D, 40E, 40F Eyepiece optical device
41 Position display means (retroreflective marker)
42 Diffraction means
43 Light collection means
44 Holding member
45 Glass window
46, 46A, 46B Light collection member
47, 47A, 47B Deflection member
48 Support member
49A Light collection member
49B Diffraction grating
50 First position detection device
51 Light source
52 First optical path synthesizing unit
53 Second optical path synthesizing unit
54 Light receiving unit
55 Coupling lens
56 Lens member
60 Second position detection device

### 70 Observer

### 71 Pupil

### 80 Room

81 Wall surface

### 82 Seat

### 140 Frame

### 140′ Nose pad

### 141 Front

### 142 Hinge

### 143 Temple

### 144 Temple tip

What is claimed is:

1. A display apparatus comprising:
an eyepiece optical device; and
an image display device including an image forming device and a transfer optical device that emits an image incident from the image forming device to the eyepiece optical device, wherein
the eyepiece optical device and the image display device are spatially separated from each other,
the eyepiece optical device forms the image from the transfer optical device on a retina of an observer,
the image display device further includes
a control unit,
a first position detection device and a second position detection device that detect a position of the eyepiece optical device, and
a transfer-optical-device control device, and
the transfer-optical-device control device controls the transfer optical device such that the image incident from the image forming device reaches the eyepiece optical device under control of the control unit on a basis of position information of the eyepiece optical device detected by the first position detection device, and the control unit corrects the position detected by the first position detection device on a basis of position information of the eyepiece optical device detected by the second position detection device.

2. The display apparatus according to claim 1, wherein the control unit controls formation of the image in the image forming device on a basis of the position information of the eyepiece optical device detected by the first position detection device, by the second position detection device, or by the first position detection device and the second position detection device.

3. The display apparatus according to claim 1, wherein
the first position detection device includes
a light source,
a first optical path synthesizing unit,
a second optical path synthesizing unit, and
a light receiving unit,
the image incident from the image forming device is formed on the retina of the observer via the second optical path synthesizing unit, the transfer optical device, and the eyepiece optical device, and
light emitted from the light source reaches the eyepiece optical device via the first optical path synthesizing unit, the second optical path synthesizing unit, and the transfer optical device, is returned to the transfer optical device by the eyepiece optical device, is incident on the first optical path synthesizing unit via the transfer optical device and the second optical path synthesizing unit, is emitted from the first optical path synthesizing unit in a direction different from a direction of the light source, and is incident on the light receiving unit.

4. The optical device according to claim 3, wherein in a case where an incident position of the light incident on the light receiving unit from the first optical path synthesizing unit shifts from a predetermined position, the transfer-optical-device control device controls a position of the transfer optical device so as to eliminate the shift.

5. The display apparatus according to claim 3, wherein an emission angle of light from the transfer optical device, the light having been emitted from a center of the light source, is different from an emission angle of light from the transfer optical device, the light having been emitted from a center of the image forming device.

6. The display apparatus according to claim 3, wherein the light source emits an infrared ray in an eye-safe wavelength band.

7. The display apparatus according to claim 3, wherein the light emitted from the light source and incident on the first optical path synthesizing unit is divergent light.

8. The display apparatus according to claim 3, wherein the light receiving unit is arranged at a position closer to the first optical path synthesizing unit than to a position optically conjugate with the light source.

9. The display apparatus according to claim 3, wherein the light receiving unit includes a position sensitive detector, a multi-segmented photodiode, or a plurality of photodiodes.

10. The display apparatus according to claim 1, wherein the first position detection device also serves as the second position detection device.

11. The display apparatus according to claim 1, wherein the transfer-optical-device control device causes the transfer optical device to perform image projection control on the retina of the observer in a horizontal direction and a vertical direction of the image to be formed on the retina of the observer.

12. The optical device according to claim 1, wherein the transfer optical device includes a combination of two galvanometer mirrors.

13. The optical device according to claim 1, wherein a retroreflective element is attached to the eyepiece optical device.

14. The display apparatus according to claim 1, wherein the eyepiece optical device includes a diffractive optical member.

15. The display apparatus according to claim 1, wherein the eyepiece optical device includes a light collection member and a deflection member.

16. The display apparatus according to claim 1, wherein the eyepiece optical device and the image display device are relatively movable.

17. The display apparatus according to claim 1, wherein the eyepiece optical device is worn by the observer.

18. The display apparatus according to claim 1, wherein the eyepiece optical device is arranged at a position away from the observer.

19. A display apparatus comprising:
an eyepiece optical device; and
an image display device including an image forming device and a transfer optical device that emits an image incident from the image forming device to the eyepiece optical device, wherein
the eyepiece optical device and the image display device are spatially separated from each other,
the eyepiece optical device forms the image from the transfer optical device on a retina of an observer,
the image display device further includes
a control unit,
a first position detection device and a second position detection device that detect a position of the eyepiece optical device, and
a transfer-optical-device control device, and
the transfer-optical-device control device controls the transfer optical device such that the image incident from the image forming device reaches the eyepiece optical device under control of the control unit on a basis of position information of the eyepiece optical device detected by the first position detection device, and the control unit controls formation of the image in the image forming device on a basis of the position information of the eyepiece optical device detected by the first position detection device, by the second position detection device, or by the first position detection device and the second position detection device.

20. A display apparatus comprising:
an eyepiece optical device; and
an image display device including an image forming device and a transfer optical device that emits an image incident from the image forming device to the eyepiece optical device, wherein
the eyepiece optical device and the image display device are spatially separated from each other,
the eyepiece optical device forms the image from the transfer optical device on a retina of an observer,
the image display device further includes a first position detection device that detects a position of the eyepiece optical device,
the first position detection device includes
a light source,
a first optical path synthesizing unit,
a second optical path synthesizing unit, and
a light receiving unit,
the image incident from the image forming device is formed on the retina of the observer via the second optical path synthesizing unit, the transfer optical device, and the eyepiece optical device, and
light emitted from the light source reaches the eyepiece optical device via the first optical path synthesizing unit, the second optical path synthesizing unit, and the transfer optical device, is returned to the transfer optical device by the eyepiece optical device, is incident on the first optical path synthesizing unit via the transfer optical device and the second optical path synthesizing unit, is emitted from the first optical path synthesizing unit in a direction different from a direction of the light source, and is incident on the light receiving unit.
